(19) United States
(12) Patent Application Publication
(10) Pub. No.: US 2026/0052469 A1
(43) Pub. Date: Feb. 19, 2026

(54) POSITIONING PROCESS WITH LOW-POWER WAKEUP RECEIVER

(71) Applicant: QUALCOMM Incorporated, San Diego, CA (US)

(72) Inventors: Chao WEI, Beijing (CN); Hao XU, Beijing (CN); Yuchul KIM, San Diego, CA (US)

(21) Appl. No.: 19/101,655

(22) PCT Filed: Oct. 7, 2022
(86) PCT No.: PCT/CN2022/123727

§ 371 Date: Feb. 6, 2025

(51) Int. Cl. H04W 52/02; H04B 17/318; H04W 64/00

(52) U.S. Cl. CPC H04W 52/0229; H04B 17/328; H04W 64/00

(57) ABSTRACT

A UE may receive combined assistance data, including a first association configuration between a first set of LP-PRSs and a first set of associated DL-PRSs and a second association configuration between a second set of LP-PRSs and a second set of associated DL-PRSs. The UE may receive the first set of LP-PRSs and the second set of LP-PRSs via a first receiver and may receive the first set of associated DL-PRSs and the second set of associated DL-PRSs via a second receiver. The second receiver may be different from the first receiver. The UE may measure the first set of LP-PRSs and the second set of LP-PRSs based on the combined assistance data. The UE may update a priority for measuring the first set of associated DL-PRSs or the second set of associated DL-PRSs based on the measured first set of LP-PRSs and the measured second set of LP-PRSs.

### TECHNICAL FIELD

The present disclosure relates generally to communication systems, and more particularly, to a mobile device having a low-power (LP) wake-up receiver (LP-WUR).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may receive combined assistance data for a first set of low-power (LP) positioning reference signals (LP-PRSs), a second set of LP-PRSs, a first set of associated downlink (DL) positioning reference signals (DL-PRSs), and a second set of associated DL-PRSs. The combined assistance data may include a first association configuration between the first set of LP-PRSs and the first set of associated DL-PRSs and a second association configuration between the second set of LP-PRSs and the second set of associated DL-PRSs. The apparatus may receive the first set of LP-PRSs and the second set of LP-PRSs via a first receiver. The apparatus may receive the first set of associated DL-PRSs and the second set of associated DL-PRSs via a second receiver. The second receiver may be different from the first receiver. The apparatus may measure the first set of LP-PRSs and the second set of LP-PRSs based on the combined assistance data. The apparatus may update a priority for measuring the first set of associated DL-PRSs or the second set of associated DL-PRSs based on the measured first set of LP-PRSs and the measured second set of LP-PRSs.

In an aspect of the disclosure, a method, a computer-readable medium, and an apparatus at a first network node are provided. The apparatus may transmit combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of associated DL-PRSs and a second association configuration between the second set of LP-PRSs and the second set of associated DL-PRSs. The apparatus may receive an indication of a priority for measuring the first set of associated DL-PRSs or the second set of associated DL-PRSs based on the first set of LP-PRSs and the second set of LP-PRSs.

In an aspect of the disclosure, a method, a computer-readable medium, and an apparatus at a second network node are provided. The apparatus may transmit a first set of LP-PRSs and a second set of LP-PRSs to a first receiver of a UE. The apparatus may transmit a first set of associated DL-PRSs and a second set of associated DL-PRSs to a second receiver. The second receiver may be different from the first receiver.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating an example of a plurality of transmission reception points (TRPs) and a UE having a plurality of radios in an access network, in accordance with various aspects of the present disclosure.

FIG. 5B is a diagram illustrating the example of FIG. 5A, where a radio of the UE is been switched to an active mode, in accordance with various aspects of the present disclosure.

FIG. 6 is a communication flow diagram of a UE, serving network node, neighbor network node, and location management function (LMF) in an access network, in accordance with various aspects of the present disclosure.

FIG. 7 is a communication flow diagram of a UE, serving network node, neighbor network node, and LMF in an access network, in accordance with various aspects of the present disclosure.

FIG. 8 is a communication flow diagram of a UE, serving network node, neighbor network node, and LMF in an access network, in accordance with various aspects of the present disclosure.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

FIG. 14 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

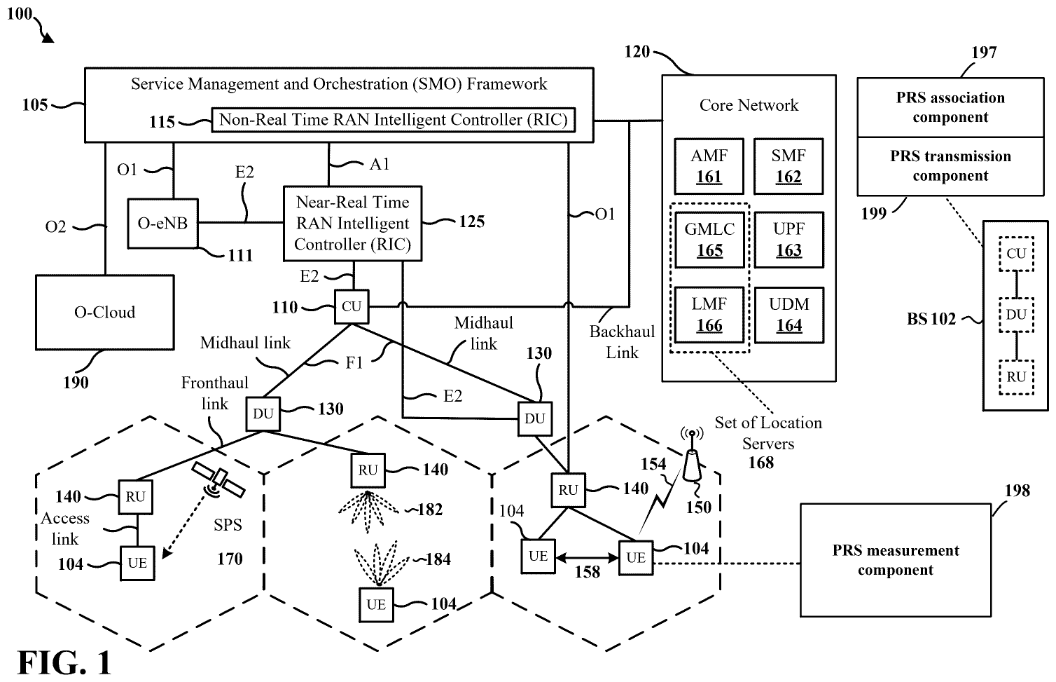

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and a velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a PRS measurement component 198 configured to receive combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of associated DL-PRSs and a second association configuration between the second set of LP-PRSs and the second set of associated DL-PRSs. The PRS measurement component 198 may be configured to receive the first set of LP-PRSs and the second set of LP-PRSs via a first receiver. The PRS measurement component 198 may be configured to the first set of associated DL-PRSs and the second set of associated DL-PRSs via a second receiver. The second receiver may be different from the first receiver. The PRS measurement component 198 may be configured to measure the first set of LP-PRSs and the second set of LP-PRSs based on the combined assistance data. The PRS measurement component 198 may be configured to update a priority for measuring the first set of associated DL-PRSs or the second set of associated DL-PRSs based on the measured first set of LP-PRSs and the measured second set of LP-PRSs. In certain aspects, the base station 102 may have a PRS association component 197 configured to transmit combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of associated DL-PRSs and a second association configuration between the second set of LP-PRSs and the second set of associated DL-PRSs. The PRS association component 197 may be configured to receive an indication of a priority for measuring the first set of associated DL-PRSs or the second set of associated DL-PRSs based on the first set of LP-PRSs and the second set of LP-PRSs. In certain aspects, the base station 102 may have a PRS transmission component 199 configured to transmit a first set of LP-PRSs and a second set of LP-PRSs to a first receiver of a UE. The PRS transmission component 199 may be configured to transmit a first set of associated DL-PRSs and a second set of associated DL-PRSs to a second receiver. The second receiver may be different from the first receiver. Although the following description may be focused on positioning using a LP-WUR and a MR, the concepts described herein may be applicable to positioning using any two receivers of a wireless device, where one receiver may have less power or functionality than the other receiver. Although the following description may be focused on 5G NR, the concepts described herein may be applicable to other similar areas, such as LTE, LTE-A, CDMA, GSM, and other wireless technologies.

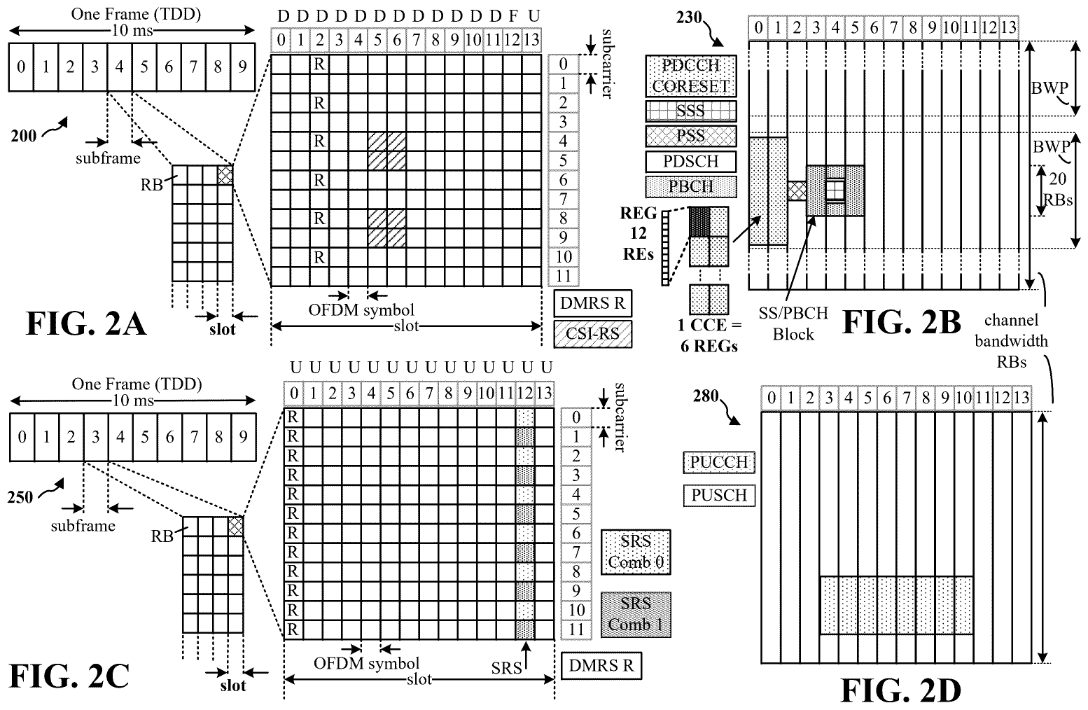

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

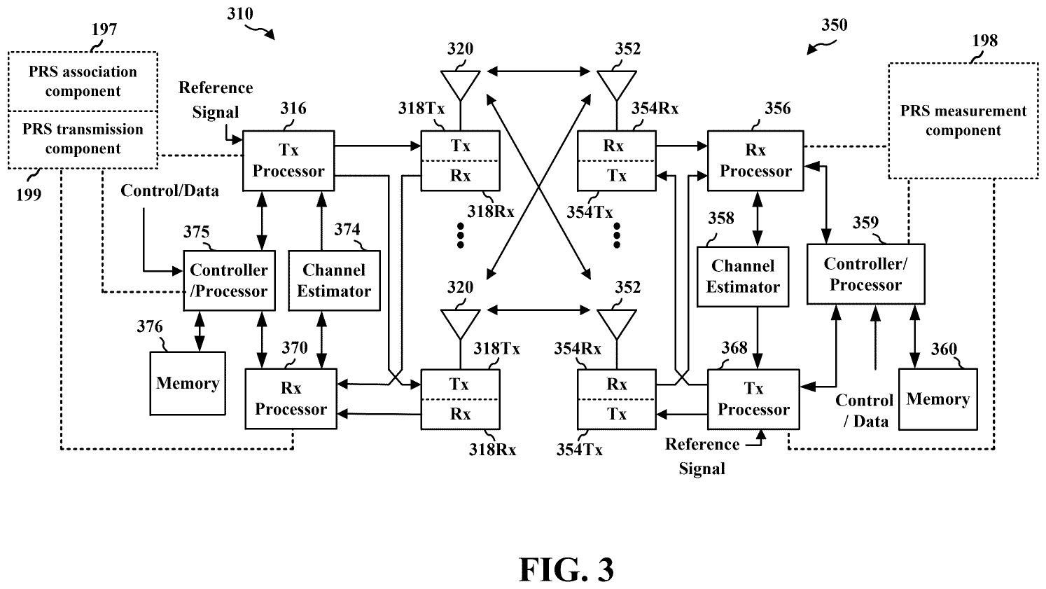

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the PRS measurement component 198 of FIG. 1.

At least one of the Tx processor 316, the Rx processor 370, and the controller/processor 375 may be configured to perform aspects in connection with the PRS association component 197 of FIG. 1. At least one of the Tx processor 316, the Rx processor 370, and the controller/processor 375 may be configured to perform aspects in connection with the PRS transmission component 199 of FIG. 1.

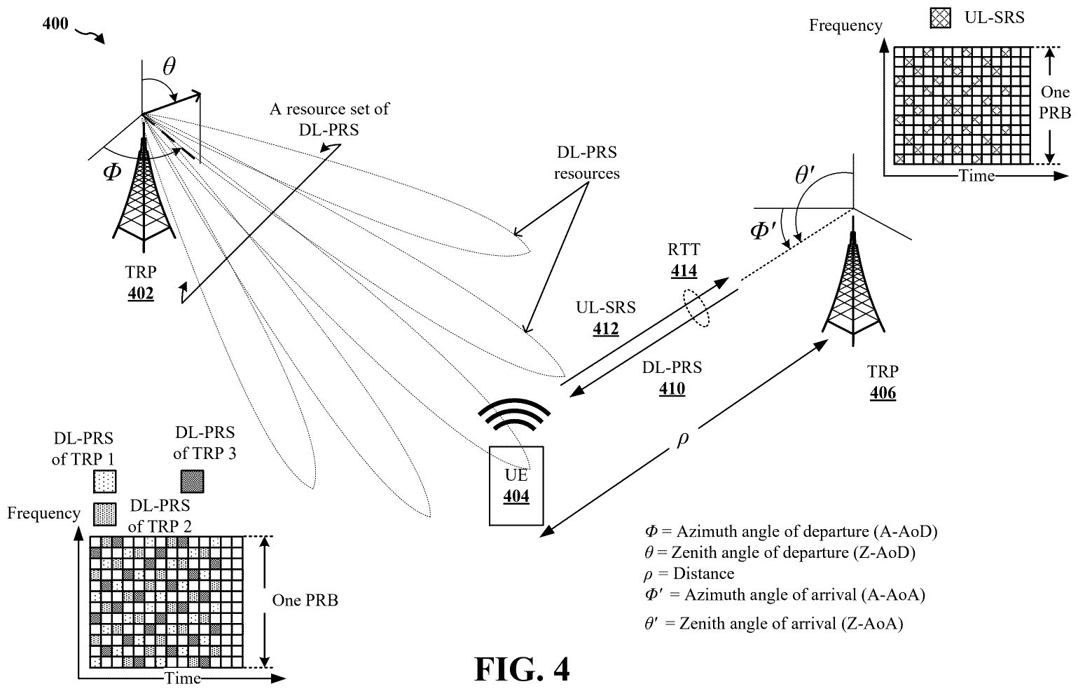

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time TPRS TX. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and DL-PRS-RSRP of the received signals) using assistance data received from the positioning server, and the TRPs 402, 406 measure the gNB Rx-Tx time difference measurements (and UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and DL-PRS-RSRP) of downlink signals received from multiple TRPs 402, 406 at the UE 404. The UE 404 measures the DL RSTD (and DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and UL-SRS-RSRP) at multiple TRPs 402, 406 of uplink signals transmitted from UE 404. The TRPs 402, 406 measure the UL-RTOA (and UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

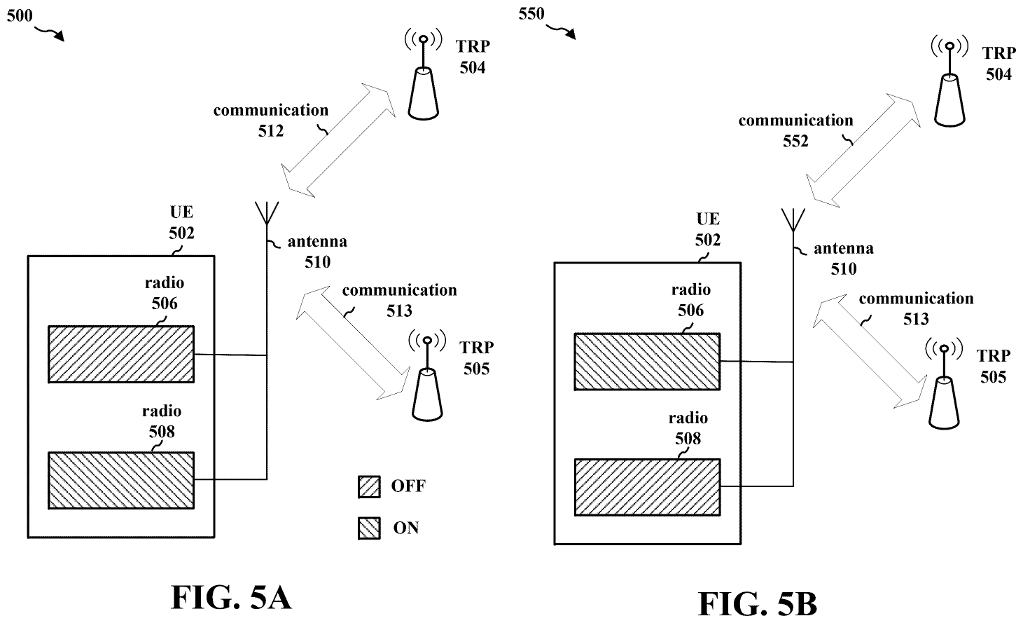

FIG. 5A is a diagram 500 illustrating a UE 502 in wireless communication with a TRP 504 and a TRP 505. The UE 502 has a radio 506 that is in an OFF mode, or a sleep mode (i.e., a deep sleep mode), and a radio 508 that is in an ON mode, or an active mode. The radio 506 may be, for example a main radio (MR) of the UE 502. The radio 508 may be, for example, a low-power (LP) wake-up receiver (LP-WUR) of the UE 502. The radio 508 may be a companion receiver that monitors for an LP wake-up signal (LP-WUS). The radio 508 may have a lower power consumption than the radio 506. If the UE 502 is not scheduled to transmit or receive data in a time period, the UE 502 may be configured to switch the radio 506 to an OFF mode, or a sleep mode, during that time period. In other words, the UE 502 may be configured to switch the radio 506 to a sleep mode unless there is something to transmit. The radio 508 may be in an active mode, which monitors for receipt of a signal, such as a LP-WUS. The radio 506 and the radio 508 may share an antenna 510 to communicate with one or more network nodes, such as the TRP 504 via communication 512 or the TRP 505 via communication 513. The UE 502 may be configured to monitor for communication 512 from the TRP 504 or the communication 513 from the TRP 505 for a signal, such as an LP-WUS. In some aspects, the radio 506 and the radio 508 may use separate antennas to communicate with one or more network nodes. While the UE 502 is shown as having two radios, a UE may have more than two radios in other aspects, for example three radios, four radios, or more, with similar power consumption levels, or with different power consumption levels. The radio 506 may also be referred to as a high-power radio (HPR). The radio 508 may be referred to as a low-power radio (LPR). The radio 506 may be configured to receive and measure orthogonal frequency division multiplexing (OFDM) waveforms. The radio 508 may be configured to receive and measure on-off keying (OOK) waveforms or an amplitude-shift keying based modulated waveforms. The radio 508 may not be configured to receive and measure OFDM waveforms.

FIG. 5B is a diagram 550 illustrating the UE 502 of FIG. 5B with the radio 506 switched to an ON, or active mode and the radio 508 switched to an OFF, or inactive mode, or a sleep mode. If the UE 502 is scheduled to transmit or receive data during a time period, the UE 502 may be configured to switch the radio 506 to an ON mode, or an active mode, during that time period. In other words, the UE 502 may be configured to switch the radio 506 to an active mode when there is something to transmit.

In some aspects, the TRP 504 may transmit a communication 512 to the radio 508 of the UE 502, which includes an on-demand LP-WUS. In some aspects, the TRP 505 may transmit a communication 513 to the radio 508 of the UE 502, which includes an on-demand LP-WUS. In response, the UE 502 may switch the radio 506 to from the inactive mode in FIG. 5A to the active mode in FIG. 5B. When the radio 506 is in active mode, the UE 502 may transmit and receive data with the TRP 504 via the radio 506 using communication 552, or may transmit and receive data with the TRP 505 via the radio 506 using communication 513.

Use of a low power radio, such as the radio 508, may reduce total power consumption and latency at the UE 502 by minimizing the time that the radio 506 is in an active mode. If the radio 506 is costly in power consumption, avoiding an unnecessary wake up of the radio 506 may reduce power consumption at the UE 502. If the radio 508 consumes very low power compared to the radio 506, the radio 508 may be configured to frequently monitor for LP-WUS signals as the communication 512 or the communication 513 to meet latency conditions of the UE 502. In some aspects, the radio 508 may be configured for paging reception from the TRP 504 and/or the TRP 505. In some aspects, the radio 508 may be configured to monitor for other LP signals, such as an LP reference signal (LP-RS). The UE 502 may use the LP-RS for time tracking or frequency tracking. The UE 502 may use the LP-RS for radio resource management (RRM) measurements. By monitoring LP-RS signals, the UE 502 may offload serving cell RRM from the radio 506 to the radio 508 to reduce the frequency for the radio 506 to be in active mode and to help save power at the UE 502.

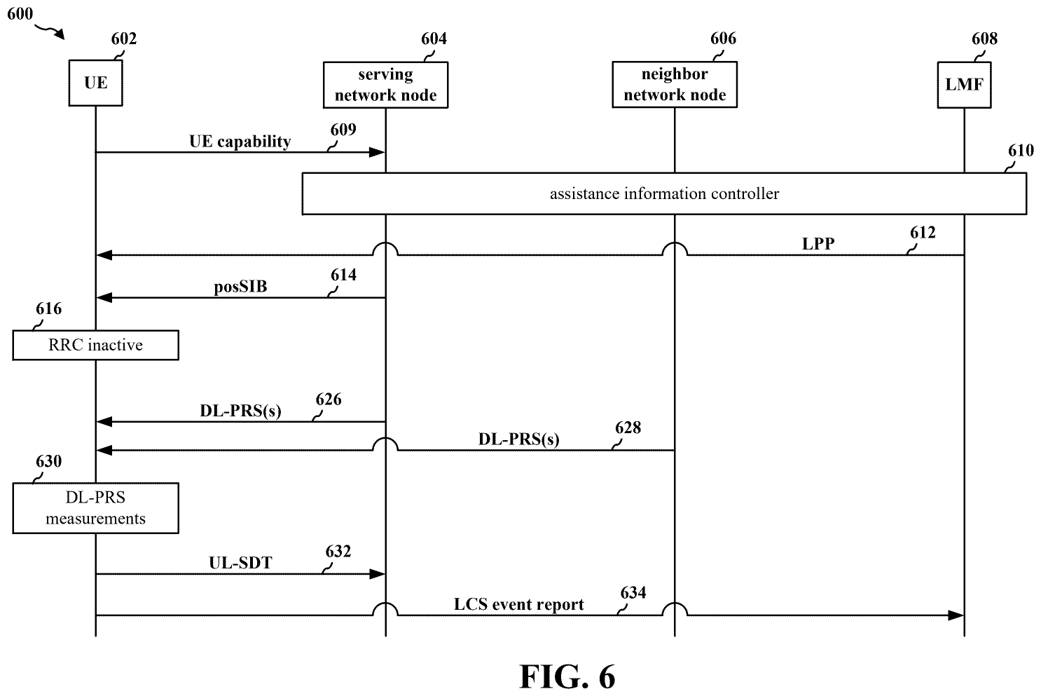

FIG. 6 is a communication flow diagram 600 of a UE 602, such as the UE 104 in FIG. 1 or the UE 502 in FIGS. 5A and 5B, configured to communicate with the serving network node 604, one or more neighbor network nodes, such as the neighbor network node 606, and a location management function (LMF) 608. In some aspects, the UE 602 may be configured to perform positioning measurements while the UE 602 is in a radio resource control (RRC) inactive state. By configuring the UE 602 to perform positioning measurements while the UE 602 is in an RRC inactive state, the UE 602 may perform positioning measurements without switching to an RRC connected mode or RRC connected state. The UE 602 may have an HPR, such as the radio 506 in FIGS. 5A and 5B, which may measure DL-PRS signals from a network node, for example the set of DL-PRSs 626 from the serving network node 604 or the set of DL-PRSs 628 from the neighbor network node 606.

The UE 602 may transmit a UE capability 609 to the serving network node 604. The UE capability 609 may include an indicator of a capability of the UE 602 to receive and/or measure a set of DL-PRSs. For example, the UE capability 609 may indicate a maximum number of resources that the UE 602 is able to read in a time period.

An assistance information controller 610 may be configured to communicate with the serving network node 604, the neighbor network node 606, and the LMF 608. The assistance information controller 610 may be, for example, the core network 120, the Near-RT RIC 125, or the Non-RT RIC 115 in FIG. 1. The assistance information controller 610 may provide assistance data to support downlink (DL) positioning while the UE 602 is in RRC inactive mode. In one aspect, the LMF 608 may generate a long term evolution (LTE) positioning protocol (LPP) message using the assistance information controller 610 to configure the UE 602 for DL positioning. The LPP message may include, for example, a non-access stratum (NAS) message. The LMF 608 may transmit an LPP 612 to the UE 602. The UE 602 may receive the LPP 612 from the LMF 608. In other aspects, the serving network node 604 may generate a positioning system information block (posSIB) using the assistance information controller 610 to configure the UE 602 for DL positioning. The serving network node 604 may transmit the posSIB 614 to the UE 602. The UE 602 may receive the posSIB from the serving network node.

At 616, the UE 602 may switch to an RRC inactive mode. The UE 602 may have been preconfigured for DL positioning using the LPP 612 and/or the posSIB 614. At 630, the UE 602 may perform positioning measurements based on the sets of received DL-PRSs. The serving network node 604 may transmit a set of DL-PRSs 626, which may be used for positioning. The neighbor network node 606 may transmit a set of DL-PRSs 628 which may be used for positioning. The UE 602 may have an HPR configured to be in active mode to receive the set of DL-PRSs. The UE 602 may receive the set of DL-PRSs 626 from the serving network node 604. The UE 602 may receive the set of DL-PRSs 628 from the neighbor network node 606. While one neighbor network node is shown in the communication flow diagram 600 in FIG. 6, the UE 602 may receive DL-PRSs from a plurality of neighbor network nodes in other aspects.

At 630, the UE 602 may measure the sets of DL-PRSs. The UE 602 may measure the set of DL-PRSs 626 received from the serving network node 604. The UE 602 may measure the set of DL-PRSs 628 received from the neighbor network node 606. In some aspects, the UE 602 may transmit a measurement report as the uplink (UL) small data transmission (UL-SDT) 632 to the serving network node 604. The UE 602 may transmit the UL-SDT 632 from its HDR. In some aspects, the UE 602 may transmit a location service (LCS) event report 634 to the LMF 608. The LCS event report 634 may be based on the measurements taken at 630. The UE 602 may transmit the LCS event report 634 from its HDR. In summary, the UE 602 may transmit the measurements it took at 630 without transitioning to an RRC connected state, remaining in RRC inactive mode while transmitting the UL-SDT 632 and/or the LCS event report 634.

In some aspects, the DL-PRSs, such as the set of DL-PRSs 626 and the set of DL-PRSs 628, may exceed the ability of the UE 602 to receive and measure each of the DL-PRSs. If the assistance data exceeds the capability of the UE 602 to process the DL-PRSs, the UE 602 may be configured to prioritize the DL-PRSs, measuring a subset of the DL-PRSs that are of the highest priority to the UE 602. In some aspects, the LMF 608 may determine a prioritization of the configured DL-PRS resources. For example, for each frequency layer, a number of TRPs (e.g., up to 64 TRPs) may be sorted according to priority. For each TRP of the number of TRPs, the LMF 608 may sort up to two DL-PRS resource sets according to priority. The set of DL-PRS resources (e.g., up to 2 DL-PRS resource sets for up to 64 TRPs) may be sorted in the decreasing order of priority for measurement. If the total number of the set of DL-PRS resources exceed the reported capability of the UE 602, then the UE 602 may measure a subset of the set of DL-PRS resources-those with the highest priority.

The UE 602 may be configured to prioritize a subset of DL-PRSs in any suitable manner, for example by prioritizing DL-PRSs from TRPs that are physically closer to the UE 602. However, the UE 602 may prioritize the set of DL-PRSs 626 from the serving network node 604 over the set of DL-PRSs 628 from the neighbor network node 606 while it is in an RRC connected state in response to detecting that the UE 602 is closer to the serving network node 604 than the neighbor network node 606, but may move to be closer to the neighbor network node 606 when the UE 602 is in an RRC inactive state. This may negatively affect the positioning accuracy and efficiency of positioning at the UE 602, as the UE 602 may no longer be prioritizing receiving and measuring DL-PRSs from a closer network node.

While the UE 602 in an RRC inactive state may be configured to periodically measure all DL-PRSs using its HPR for measuring the DL-PRSs, use of the HPR so frequently may consume a great deal of power. In some aspects, the UE 602 may be configured the set of DL-PRSs 626 and the set of DL-PRSs 628 to align with the paging discontinuous reception (DRX) cycle of the UE 602, which may allow the UE 602 to put its HPR to sleep and switch to an active mode periodically to receive the DL-PRSs. However, a network may transmit DL-PRSs to a plurality of UEs in a cell, and a paging DRX cycle may be specific to each UE. Configuring the set of DL-PRSs 626 and the set of DL-PRSs 628 to align with the paging DRX cycle of the UE 602 may prevent other UEs from receiving the DL-PRSs that are not aligned with the DRX cycle of the UE 602. While the network may adjust the configuration of DL-PRSs (e.g., periodicity, offset, duration) for some of the UEs that are in RRC connected mode, the network may not be able to adjust the configuration of DL-PRSs for the UEs that are in RRC inactive mode. In some aspects, the UE 602 may be configured to monitor the set of DL-PRSs using an LPR instead of its HDR. However, some LPRs may not be configured to receive the set of DL-PRSs using OFDM waveforms. For example, the serving network node 604 may transmit the set of DL-PRSs 626 using an OFDM waveform, but the LPR of the UE 602 may have a lower complexity decoder does not support OFDM waveforms (e.g., envelope detector based). Moreover, some LPRs may not provide the same positioning accuracy as the HPR of the UE 602 due to limited measurement capability and narrowband capabilities. The assistance data of the LPP 612 and/or the posSIB 614 may configure the UE 602 to perform DL time delay of arrival (DL-TDOA) positioning techniques or multi-cell round trip time (RTT) positioning techniques, where path delay is measured and the accuracy of the technique is dependent upon the bandwidth of the measured signal. An LPR with a limited ability to measure bandwidth may not be able to perform such positioning techniques accurately.

Thus, it may be beneficial to improve positioning techniques using an LPR to save power at the UE, for example by performing joint positioning with both an LPR and an HPR to save power at the UE. In some aspects, a UE may be configured to receive combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of DL-PRSs and a second association configuration between the second set of LP-PRSs and the second set of associated DL-PRSs. The UE may be configured to receive the first set of LP-PRSs and the second set of LP-PRSs via a first receiver. The UE may be configured to receive the first set of DL-PRSs and the second set of associated DL-PRSs via a second receiver. The second receiver may be different from the first receiver. The UE may be configured to measure the first set of LP-PRSs and the second set of LP-PRSs based on the combined assistance data. The UE may be configured to update a priority for measuring the first set DL-PRSs or the second set of associated DL-PRSs based on the measured first set of LP-PRSs and the measured second set of LP-PRSs. A first network node may be configured to transmit combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of DL-PRSs and a second association configuration between the second set of LP-PRSs and the second set of associated DL-PRSs. The first network node may be configured to receive an indication of a priority for measuring the first set DL-PRSs or the second set of associated DL-PRSs based on the first set of LP-PRSs and the second set of LP-PRSs. A second network node may be configured to transmit a first set of LP-PRSs and a second set of LP-PRSs from a first TRP to a first receiver of a UE. The second network node may be configured to transmit a first set of associated DL-PRSs and a second set of associated DL-PRSs from a second TRP to a second receiver. The second receiver may be different from the first receiver.

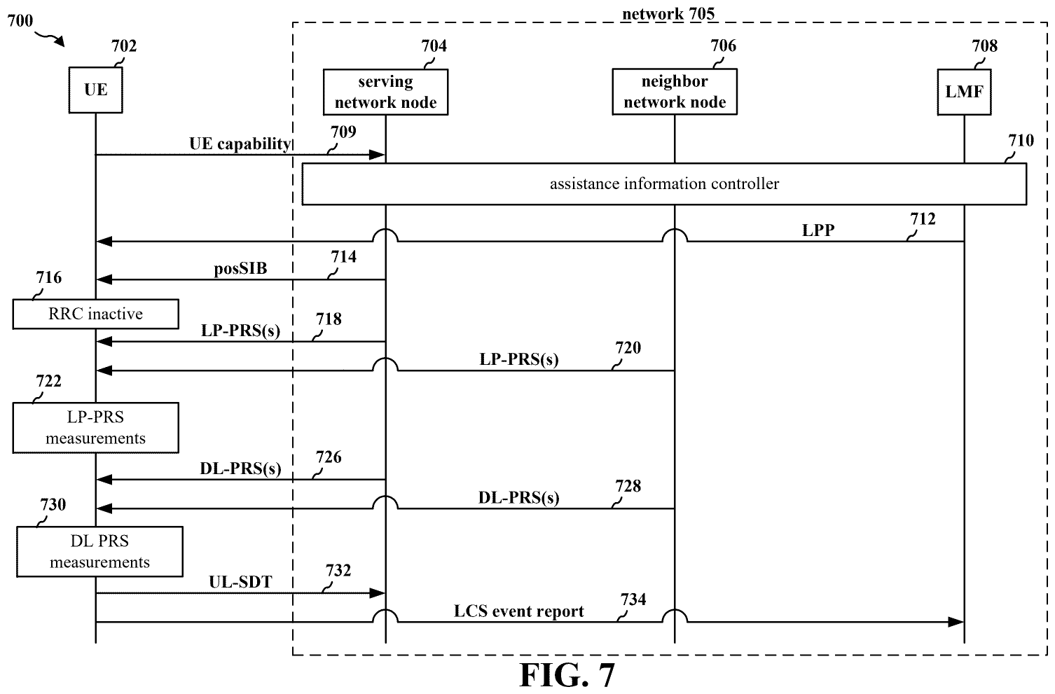

FIG. 7 is a communication flow diagram 700 of a UE 702, such as the UE 104 in FIG. 1 or the UE 502 in FIGS. 5A and 5B, configured to communicate with the serving network node 704, one or more neighbor network nodes, such as the neighbor network node 706, and an LMF 708. In some aspects, the UE 702 may be configured to perform positioning measurements while the UE 702 is in an RRC inactive state. By configuring the UE 702 to perform positioning measurements while the UE 702 is in an RRC inactive state, the UE 702 may perform positioning measurements without switching to an RRC connected mode or RRC connected state. The UE 702 may have an HPR, such as the radio 506 in FIGS. 5A and 5B, which may measure DL-PRS signals from a network node, for example the set of DL-PRSs 726 from the serving network node 704 or the set of DL-PRSs 728 from the neighbor network node 706. The UE 702 may also have an LPR, such as the radio 508 in FIGS. 5A and 5B, which may measure LP-PRS signals from a network node, for example the set of LP-PRSs 718 from the serving network node 704 or the set of LP-PRSs 720 from the neighbor network node 706. The serving network node 704, the neighbor network node 706, and the LMF 708 may be considered components of the network 705 in communication with one another, for example via a plurality of backhaul links and/or midhaul links.

The DL-PRSs may be transmitted using high complexity waveforms that an LPR of the UE 702 may not be configured to receive and measure. For example, the set of DL-PRSs 726 and/or the set of DL-PRSs 728 may be transmitted using OFDM waveforms. The LP-PRSs may be transmitted using low complexity waveforms that the LPR of the UE 702 may be configured to receive and measure. For example, the set of LP-PRSs 718 and/or the set of LP-PRSs 720 may be transmitted using OOK waveforms or amplitude-shift keying based modulated waveforms.

The UE 702 may transmit a UE capability 709 to the serving network node 704. The UE capability 709 may include an indicator of a capability of the UE 702 to receive and/or measure a set of DL-PRSs and/or a set of LP-PRSs. For example, the UE capability 709 may indicate a maximum number of resources that the UE 702 is able to read in a time period. The maximum number of resources for DL-PRS and LP-PRS may be separately indicated based on the capability of the corresponding receiver.

An assistance information controller 710 may be configured to communicate with the serving network node 704, the neighbor network node 706, and the LMF 708. The assistance information controller 710 may be, for example, the core network 120, the Near-RT RIC 125, or the Non-RT RIC 115 in FIG. 1. The assistance information controller 710 may provide assistance data to support downlink (DL) positioning while the UE 702 is in RRC inactive mode. In one aspect, the LMF 708 may generate a long term evolution (LTE) positioning protocol (LPP) message using the assistance information controller 710 to configure the UE 702 for DL positioning. The LPP message may include, for example, a non-access stratum (NAS) message. The LMF 708 may transmit an LPP 712 to the UE 702. The UE 702 may receive the LPP 712 from the LMF 708. In other aspects, the serving network node 704 may generate a positioning system information block (posSIB) using the assistance information controller 710 to configure the UE 702 for DL positioning. The serving network node 704 may transmit the posSIB 714 to the UE 702. The UE 702 may receive the posSIB from the serving network node. The LPP 712 and/or the posSIB 714 may include combined assistance data that configures the set of LP-PRSs and the set of DL-PRSs transmitted to the UE 702, for example the set of LP-PRSs 718 from the serving network node 704, the set of LP-PRSs 720 from the neighbor network node 706, the set of DL-PRSs 726 from the serving network node 704, and/or the set of DL-PRSs from the neighbor network node 706.

The assistance data may include combined data that includes an association configuration between a first set of LP-PRSs and a first set of DL-PRSs and a second set of LP-PRSs and a second set of associated DL-PRSs. For example, the assistance data may associate the set of LP-PRSs 718 from the serving network node 704 with the set of DL-PRSs 726 from the serving network node 704, and may associate the set of LP-PRSs 720 from the neighbor network node 706 with the set of DL-PRSs 728 from the neighbor network node 706. In some aspects, the assistance data may differentiate between sets of LP-PRSs or DL-PRSs from the same TRP. An example of an assistance data configuration is shown below as Table 2.

TABLE 2

| | |
|---|---|
| LP-PRS | DL-PRS |

| TRP #1 | TRP #2 | TRP #1 | TRP #2 |
|---|---|---|---|
| LP-PRS #1 | | DL-PRS #1 | |
| | | DL-PRS #2 | |
| | | DL-PRS #3 | |
| | LP-PRS #2 | | DL-PRS #4 |
| | | | DL-PRS #5 |
| | | | DL-PRS #6 |
| | LP-PRS #3 | | DL-PRS #7 |
| | LP-PRS #4 | | DL-PRS #8 |
| | | | DL-PRS #9 |

The table above shows TRP level and PRS resource set level associations between various LP-PRS and DL-PRS. A network may transmit three sets of LP-PRS to a UE-[LP-PRS #1], [LP-PRS #2], and [LP-PRS #3, LP-PRS #4]. The network may also transmit three sets of DL-PRS to a UE-[DL-PRS #1, DL-PRS #2, DL-PRS #3], [DL-PRS #4, DL-PRS #5, DL-PRS #6], and [DL-PRS #7, DL-PRS #8, DL-PRS #9]. The assistance data may associate the set of LP-PRSs [LP-PRS #1] with the set of DL-PRSs [DL-PRS #1, DL-PRS #2, DL-PRS #3], may associate the set of LP-PRSs [LP-PRS #2] with the set of DL-PRSs [DL-PRS #4, DL-PRS #5, DL-PRS #6], and may associate the set of LP-PRSs [LP-PRS #3, LP-PRS #4] with the set of DL-PRSs [DL-PRS #7, DL-PRS #8, DL-PRS #9]. An associated DL-PRS may be one that is associated with at least one LP-PRS.

The combined assistance data between the set of LP-PRSs and the set of DL-PRSs may be on the TRP level (i.e., TRP-level association), the PRS resource set level (i.e., PRS resource set-level association), or the resource level (i.e., resource-level association). In one aspect, combined assistance data between a set of LP-PRSs and a set of DL-PRSs on the TRP level may associate LP-PRS sent from a TRP with DL-PRS sent from the same TRP. For example, the set of LP-PRSs [LP-PRS #1] sent from the TRP #1 in Table 2 may be associated with the set of DL-PRSs [DL-PRS #1, DL-PRS #2, DL-PRS #3] sent from the TRP #1 in Table 2. In another example, the set of LP-PRSs 718 in FIG. 7 sent from the serving network node 704 may be associated with the set of DL-PRSs 726 in FIG. 7 sent from the serving network node 704. In one aspect, combined assistance data between a set of LP-PRSs and a set of DL-PRSs on the PRS resource set level may associate a set of LP-PRSs with a set of DL-PRSs based on boresight direction information (i.e., azimuth angle and/or elevation angle). For example, the set of LP-PRSs [LP-PRS #2] may be associated with the set of DL-PRSs [DL-PRS #4, DL-PRS #5, DL-PRS #6] and the set of LP-PRSs [LP-PRS #3, LP-PRS #4] may be associated with the set of DL-PRSs [DL-PRS #7, DL-PRS #8, DL-PRS #9] in Table 2. While each of the PRSs [LP-PRS #2, LP-PRS #3, LP-PRS #4, DL-PRS #4, DL-PRS #5, DL-PRS #6, DL-PRS #7, DL-PRS #8, DL-PRS #9] may be transmitted from the same TRP #2, they may belong to different associated sets. The combined assistance data may include boresight direction information for each LP-PRS resource and each DL-PRS resource, and the UE 702 may build an association between LP-PRS resources and DL-PRS resources based on the same boresight direction values (e.g., beam-level association). In one aspect, combined assistance data between a set of LP-PRSs and a set of DL-PRSs on the resource level may explicitly associate each LP-PRS with a DL-PRS. Each LP-PRS resource may correspond with one or more DL-PRS resources in another DL-PRS resource set of the same TRP. In other words, while a TRP level association may identify an association between LP-PRS or DL-PRS and a TRP, and a PRS resource set level association may identify an association between a set of LP-PRS and a set of DL-PRS, a resource level association may identify an association between a unique identifier of an LP-PRS and a unique identifier of a DL-PRS.

The combined assistance data of the LPP 712 and/or the posSIB 714 may provide the UE 702 with a spatial relationship between a set of LP-PRSs and a set of DL-PRSs (e.g., associate PRSs that use the same or adjacent Tx beams from a TRP to the UE 702). Since the combined assistance data may associate any set of LP-PRSs with any other set of DL-PRSs, the UE 602 may not restrict the association by the same Rx beam to measure the associated resources of the set of LP-PRSs and the associated set of DL-PRSs. The UE 602 may use the combined assistance data to determine a processing prioritization of DL-PRS resources or to perform beam refinement for a DL angle of departure (DL-AoD), as explained below.

At 716, the UE 702 may switch to an RRC inactive mode. The UE 702 may have been preconfigured for DL positioning using the LPP 712 and/or the posSIB 714 via the combined assistance data. The serving network node 704 may transmit the set of LP-PRSs 718 to the UE 702. The UE may receive the set of LP-PRSs 718 from the serving network node 704. The neighbor network node 706 may transmit the set of LP-PRSs 720 to the UE 702. The UE may receive the set of LP-PRSs 720 from the neighbor network node 706. At 722, the UE 702 may perform positioning measurements based on the set of LP-PRSs received by the UE 702 and configured by the combined assistance data. The UE 702 may have an LPR configured to be in active mode to receive the set of LP-PRSs. The UE 702 may receive the set of LP-PRSs 718 from the serving network node 704. The UE 702 may receive the set of LP-PRSs 720 from the neighbor network node 706. While one neighbor network node is shown in the communication flow diagram 700 in FIG. 7, the UE 702 may receive LP-PRSs from a plurality of neighbor network nodes in other aspects.

At 722, the UE 702 may measure the sets of LP-PRSs. The UE 702 may measure the set of LP-PRSs 718 received from the serving network node 704. The UE 702 may measure the set of LP-PRSs 720 received from the neighbor network node 706. The UE 702 may prioritize measuring the sets of DL-PRSs based on the measurements of the sets of LP-PRSs. Since the combined assistance data may associate a set of LP-PRSs with a set of DL-PRSs, the UE 702 may prioritize the LP-PRSs based on the measurements, and may use the prioritized list of LP-PRSs to update a priority of the DL-PRSs. The UE 702 may sort the LP-PRS based on the measurements in any suitable manner. For example, the UE 702 may sort the LP-PRS based on the measured RSRP or RSSI of each LP-PRS, ranking the LP-PRS having the highest RSRP or RSSI with the highest priority and the LP-PRS having the lowest RSRP with the lowest priority. The UE 702 may then rank the associated DL-PRS resources or the associated sets of DL-PRSs in accordance with their associated sets of LP-PRSs. For example, referring back to Table 2, the UE 702 may calculate that LP-PRS #2 has the highest RSRP, followed by the LP-PRS #3, followed by the LP-PRS #1. The UE 702 may then reprioritize the sets of DL-PRSs, prioritizing the set of DL-PRSs [DL-PRS #4, DL-PRS #5, DL-PRS #6] as the highest, then the set of DL-PRSs [DL-PRS #7, DL-PRS #8, DL-PRS #9], and lastly the set of DL-PRSs [DL-PRS #1, DL-PRS #2, DL-PRS #3]. The priority order list of the sets of LP-PRSs may be updated periodically to support the potential change of the location and/or position of the UE 702 over time.

At 730, the UE 702 may perform positioning measurements based on the set of DL-PRSs received by the UE 702. The serving network node 704 may transmit a set of DL-PRSs 726, which may be used for positioning. The neighbor network node 706 may transmit a set of DL-PRSs 728 which may be used for positioning. The UE 702 may have an HPR configured to be in active mode to receive the set of DL-PRSs. The HPR of the UE 702 may receive the set of DL-PRSs 726 from the serving network node 704. The HPR of the UE 702 may receive the set of DL-PRSs 728 from the neighbor network node 706. While one neighbor network node is shown in the communication flow diagram 700 in FIG. 7, the UE 702 may receive DL-PRSs from a plurality of neighbor network nodes in other aspects.

At 730, the UE 702 may measure the sets of DL-PRSs. The UE 702 may update a priority of measuring of the sets of DL-PRSs based on the priority of the associated sets of LP-PRSs at 722. For example, if referring back to Table 2, if the UE 702 calculates that LP-PRS #2 has the highest RSRP, followed by the LP-PRS #3, followed by the LP-PRS #1, the UE 702 may then prioritize measuring the set of DL-PRSs [DL-PRS #4, DL-PRS #5, DL-PRS #6] as the highest priority. If the UE 702 has the capability to measure additional DL-PRSs, then the UE 702 may measure the set of DL-PRSs [DL-PRS #7, DL-PRS #8, DL-PRS #9]. If the UE 702 has the capability to measure additional DL-PRSs, then the UE 702 may lastly measure the set of DL-PRSs [DL-PRS #1, DL-PRS #2, DL-PRS #3].

In some aspects, the UE 702 may transmit a measurement report as the uplink (UL) small data transmission (UL-SDT) 732 to the serving network node 704. The UE 702 may transmit the UL-SDT 732 from its HDR. In some aspects, the UE 702 may transmit an LCS event report 734 to the LMF 708. The LCS event report 734 may be based on the measurements taken at 730. The UE 702 may transmit the LCS event report 734 from its HDR. In summary, the UE 702 may transmit the measurements it took at 730 without transitioning to an RRC connected state, prioritizing the DL-PRSs accurately using the measurements of the LP-PRSs at 722, all while remaining in RRC inactive mode to transmit the UL-SDT 732 and/or the LCS event report 734.

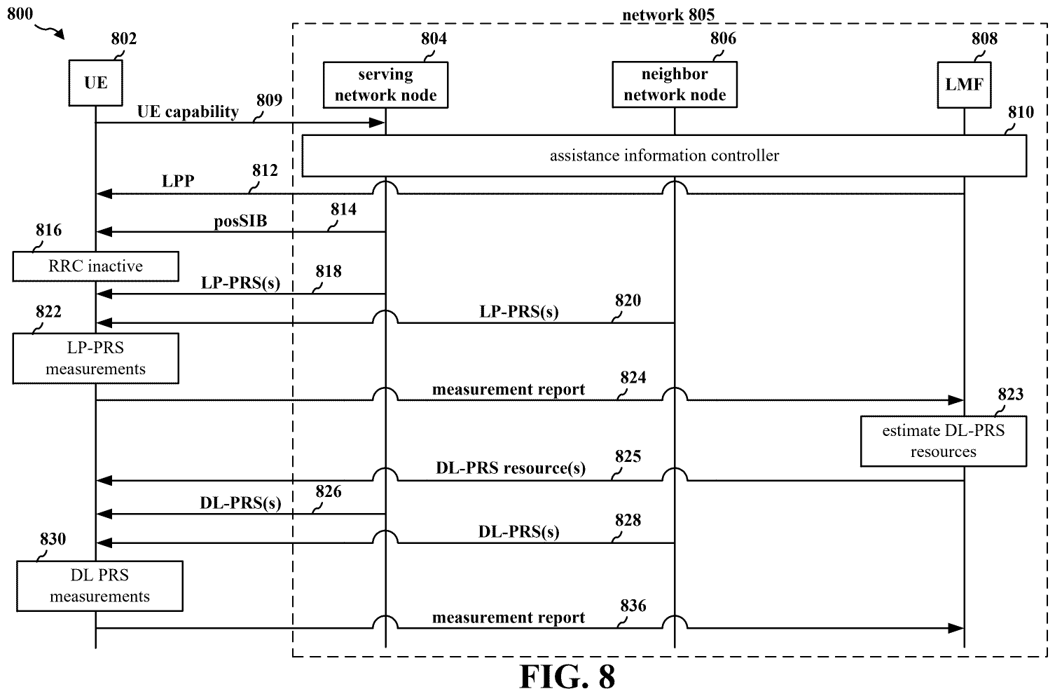

FIG. 8 is a communication flow diagram 800 of a UE 802, such as the UE 104 in FIG. 1 or the UE 502 in FIGS. 5A and 5B, configured to communicate with the serving network node 804, one or more neighbor network nodes, such as the neighbor network node 806, and an LMF 808. The UE 802 may be configured to perform positioning measurements while the UE 802 is in an RRC inactive state, similar to the UE 702 in FIG. 7. The UE 802 may have an HPR, such as the radio 506 in FIGS. 5A and 5B, which may measure DL-PRS signals from a network node, for example the set of DL-PRSs 826 from the serving network node 804 or the set of DL-PRSs 828 from the neighbor network node 806. The UE 802 may also have an LPR, such as the radio 508 in FIGS. 5A and 5B, which may measure LP-PRS signals from a network node, for example the set of LP-PRSs 818 from the serving network node 804 or the set of LP-PRSs 820 from the neighbor network node 806. The serving network node 804, the neighbor network node 806, and the LMF 808 may be considered components of one network 805 in communication with one another, for example via a plurality of backhaul links and/or midhaul links.

The DL-PRSs may be transmitted using high complexity waveforms that an LPR of the UE 802 may not be configured to receive and measure. For example, the set of DL-PRSs 826 and/or the set of DL-PRSs 828 may be transmitted using OFDM waveforms. The LP-PRSs may be transmitted using low complexity waveforms that the LPR of the UE 802 may be configured to receive and measure. For example, the set of LP-PRSs 818 and/or the set of LP-PRSs 820 may be transmitted using OOK waveforms or amplitude-shift keying based modulated waveforms.

The UE 802 may transmit a UE capability 809 to the serving network node 804. The UE capability 809 may include an indicator of a capability of the UE 802 to receive and/or measure a set of DL-PRSs and/or a set of LP-PRSs. For example, the UE capability 809 may indicate a maximum number of resources that the UE 802 is able to read in a time period.

An assistance information controller 810 may be configured to communicate with the serving network node 804, the neighbor network node 806, and the LMF 808. The assistance information controller 810 may be, for example, the core network 120, the Near-RT RIC 125, or the Non-RT RIC 115 in FIG. 1. The assistance information controller 810 may provide assistance data to support downlink (DL) positioning while the UE 802 is in RRC inactive mode. In one aspect, the LMF 808 may generate a long term evolution (LTE) positioning protocol (LPP) message using the assistance information controller 810 to configure the UE 802 for DL positioning. The LPP message may include, for example, a non-access stratum (NAS) message. The LMF 808 may transmit an LPP 812 to the UE 802. The UE 802 may receive the LPP 812 from the LMF 808. In other aspects, the serving network node 804 may generate a positioning system information block (posSIB) using the assistance information controller 810 to configure the UE 802 for DL positioning. The serving network node 804 may transmit the posSIB 814 to the UE 802. The UE 802 may receive the posSIB from the serving network node. The LPP 812 and/or the posSIB 814 may include combined assistance data that configures the set of LP-PRSs and the set of DL-PRSs transmitted to the UE 802, for example the set of LP-PRSs 818 from the serving network node 804, the set of LP-PRSs 820 from the neighbor network node 806, the set of DL-PRSs 826 from the serving network node 804, and/or the set of DL-PRSs from the neighbor network node 806.

The assistance data may be similar to the assistance data transmitted by the LPP 712 and/or the posSIB 714 in FIG. 7. The assistance data may also be represented by Table 2 above.

At 816, the UE 802 may switch to an RRC inactive mode. The UE 802 may have been preconfigured for DL positioning using the LPP 812 and/or the posSIB 814 via the combined assistance data. The serving network node 804 may transmit the set of LP-PRSs 818 to the UE 802. The UE may receive the set of LP-PRSs 818 from the serving network node 804. The neighbor network node 806 may transmit the set of LP-PRSs 820 to the UE 802. The UE may receive the set of LP-PRSs 820 from the neighbor network node 806. At 822, the UE 802 may perform positioning measurements based on the set of LP-PRSs received by the UE 802 and configured by the combined assistance data. The UE 802 may have an LPR configured to be in active mode to receive the set of LP-PRSs. The UE 802 may receive the set of LP-PRSs 818 from the serving network node 804. The UE 802 may receive the set of LP-PRSs 820 from the neighbor network node 806. While one neighbor network node is shown in the communication flow diagram 800 in FIG. 8, the UE 802 may receive LP-PRSs from a plurality of neighbor network nodes in other aspects.

At 822, the UE 802 may measure the sets of LP-PRSs. The UE 802 may measure the set of LP-PRSs 818 received from the serving network node 804. The UE 802 may measure the set of LP-PRSs 820 received from the neighbor network node 806. In some aspects, the UE 802 may perform a first step of a two-step beam refinement for DL-AoD using the measurements of the sets of LP-PRSs. For example, each TRP of the serving network node 804 may transmit the set of LP-PRSs 818 using a relatively wide beam, and each TRP of the neighbor network node 806 may transmit the set of LP-PRSs 820 using a relatively wide beam.

At 822, the UE 802 may measure the RSRP of each of the set of LP-PRSs 818 and the set of LP-PRSs 820. The UE 802 may transmit a measurement report 824 of the most suitable RSRPs based on the measurements taken at 822 to the LMF 808. The LMF 808 may receive the measurement report 824 from the UE 802. At 823, the LMF 808 may estimate the rough location of the UE 802 based on the measurement report 824. The LMF 808 may transmit a set of DL-PRS resources 825 to the UE 802. The UE 802 may receive the set of DL-PRS resources 825 from the LMF 808. The set of DL-PRS resources 825 may indicate the DL-PRS resources that correspond with the strongest narrow beams from the TRP having the most suitable measured RSRPs. The DL-PRS resources 825 may be transmitted as an LPP. The DL-PRS resources 825 may be transmitted as assistance data. In some aspects, the assistance data may indicate what additional DL-PRS resources the UE 802 may report for each LP-PRS.

At 830, the UE 802 may perform positioning measurements based on the set of DL-PRS resources 825 received from the LMF 808. The UE 802 may transmit an updated measurement report 836 based on the set of DL-PRS resources 825. The LMF 808 may receive the updated measurement report 836 from the UE 802. In summary, the UE 802 may measure, at 822, a set of LP-PRS resources with wide beams as the set of LP-PRSs 818 and the set of LP-PRSs 820 using its LPR. With the association information received as the set of DL-PRS resources 825 received from the LMF 808, the UE 802 may measure, at 830, the DL-PRS resources with narrow beams using its HPR, which are associated with the set of LP-PRS resources.

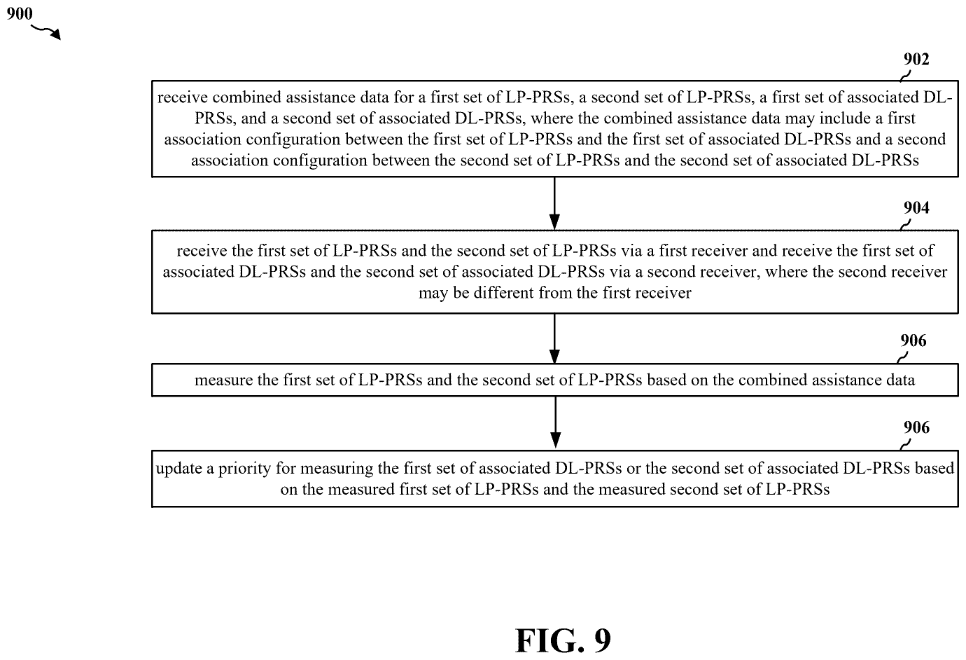

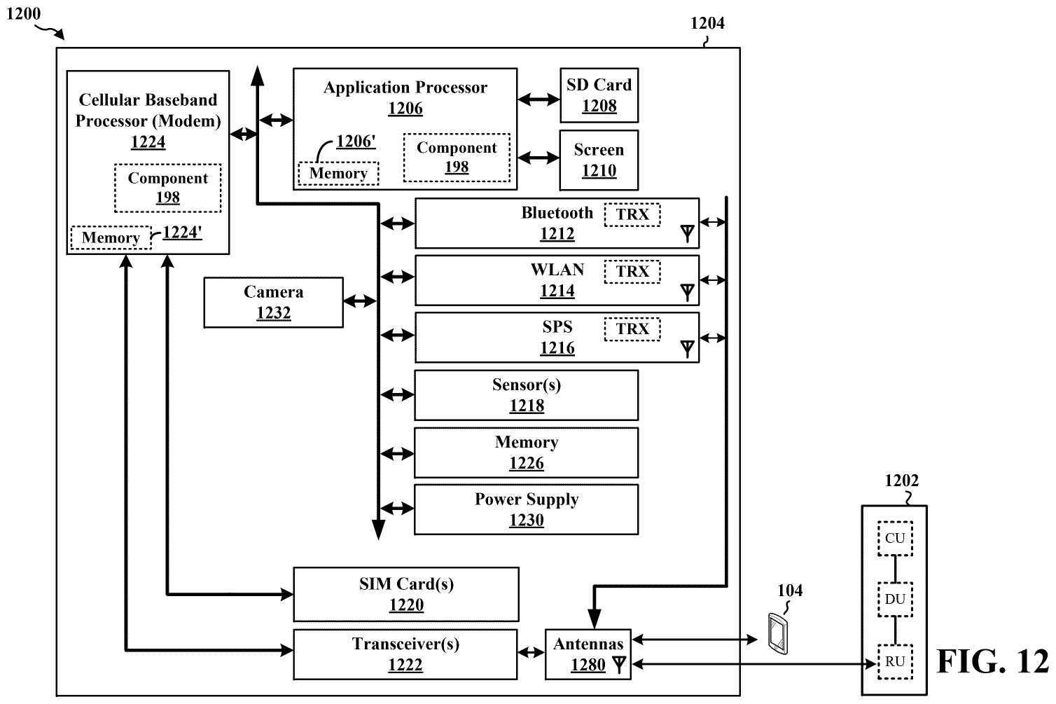

FIG. 9 is a flowchart 900 of a method of wireless communication. The method may be performed by a UE (e.g., the UE 104, the UE 350, the UE 404, the UE 502, the UE 602, the UE 702, the UE 802; the apparatus 1204). At 902, the UE may receive combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of associated DL-PRSs and a second association configuration between the second set of LP-PRSs and the second set of associated DL-PRSs. For example, 902 may be performed by the UE 702 in FIG. 7, which may receive combined assistance data as the LPP 712 from the LMF 708 and/or the posSIB 714 from the serving network node 704 for the set of LP-PRSs 718, the set of LP-PRSs 720, the set of DL-PRSs 726, and the set of DL-PRSs 728. The combined assistance data may include a first association configuration between the set of LP-PRSs 718 and the set of DL-PRSs 726 and a second association configuration between the set of LP-PRSs 720 and the set of DL-PRSs 728. Moreover, 902 may be performed by the component 198 in FIG. 12.

At 904, the UE may receive the first set of LP-PRSs and the second set of LP-PRSs via a first receiver and receive the first set of associated DL-PRSs and the second set of associated DL-PRSs via a second receiver. The second receiver may be different from the first receiver. For example, 904 may be performed by the UE 702 in FIG. 7, which may receive the set of LP-PRSs 718 from the serving network node 704 and the set of LP-PRSs 720 from the neighbor network node 706 via an LPR at the UE 702 and receive the set of DL-PRSs 726 from the serving network node 704 and the set of DL-PRSs 728 from the neighbor network node 706 via an HPR at the UE 702. The HPR at the UE 702 may be different from the LPR at the UE 702. Moreover, 904 may be performed by the component 198 in FIG. 12.

At 906, the UE may measure the first set of LP-PRSs and the second set of LP-PRSs based on the combined assistance data. For example, 906 may be performed by the UE 702 in FIG. 7, which may, at 722, measure the set of LP-PRSs 718 from the serving network node 704 and the set of LP-PRSs 720 from the neighbor network node 706 based on the combined assistance data of the LPP 712 or the posSIB 714. Moreover, 906 may be performed by the component 198 in FIG. 12.

At 908, the UE may update a priority for measuring the first set of associated DL-PRSs or the second set of associated DL-PRSs based on the measured first set of LP-PRSs and the measured second set of LP-PRSs. For example, 908 may be performed by the UE 702 in FIG. 7, which may update a priority for measuring the set of DL-PRSs 726 from the serving network node 704 or the set of DL-PRSs 728 from the neighbor network node 706 based on the measured set of LP-PRSs 718 and the measured set of LP-PRSs 720. The set of DL-PRSs 726 and the set of DL-PRSs 728 may be associated with a set of DL-PRS resources. The UE 702 may update a priority of a subset of the set of DL-PRS resources based on the measure set of LP-PRSs 718 and the measured set of LP-PRSs 720. In one aspect, for each L-PRS there may be an associated subset of DL-PRS resources. If the UE 702 assumes one LP-PRS to be a high priority based on a measurement of the LP-PRS, in response the UE 702 may assume the associated DL-PRS to be a high priority. The UE 702 may, at 722, update a priority for measuring the set of DL-PRSs 726 or the set of DL-PRSs 728 based on RSRPs associated with the set of LP-PRSs 718 and the set of RSRPs associated with the set of LP-PRSs 720. Moreover, 908 may be performed by the component 198 in FIG. 12.

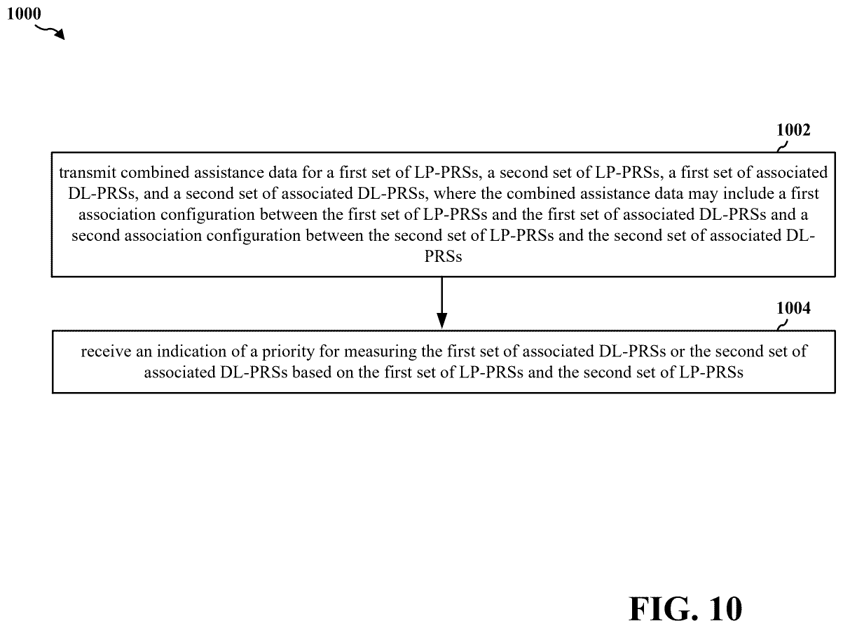

FIG. 10 is a flowchart 1000 of a method of wireless communication. The method may be performed by a first network node (e.g., the base station 102, the base station 310; the TRP 402, the TRP 406, the TRP 504, the TRP 505; the LMF 608, the LMF 708, the LMF 808; the network entity 1202, the network entity 1302, the network entity 1460). At 1002, the first network node may transmit combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of associated DL-PRSs and a second association configuration between the second set of LP-PRSs and the second set of associated DL-PRSs. For example, 1002 may be performed by the LMF 708 in FIG. 7, which may transmit the LPP 712 which may have combined assistance data for the set of LP-PRSs 718, the set of LP-PRSs 720, the set of DL-PRSs 726, and the set of DL-PRSs 728. The combined assistance data may include a first association configuration between the set of LP-PRSs 718 and the set of DL-PRSs 726 and a second association configuration between the set of LP-PRSs 720 and the set of DL-PRSs 728. Moreover, 1002 may be performed by the component 199 in FIG. 12.

At 1004, the first network node may receive an indication of a priority for measuring the first set of associated DL-PRSs or the second set of associated DL-PRSs based on the first set of LP-PRSs and the second set of LP-PRSs. For example, 1004 may be performed by the LMF 708 in FIG. 7, which may receive an indication of a priority for measuring the set of DL-PRSs 726 or the set of DL-PRSs 728 based on the set of LP-PRSs 718 and the set of LP-PRSs 720. Moreover, 1004 may be performed by the component 199 in FIG. 12.

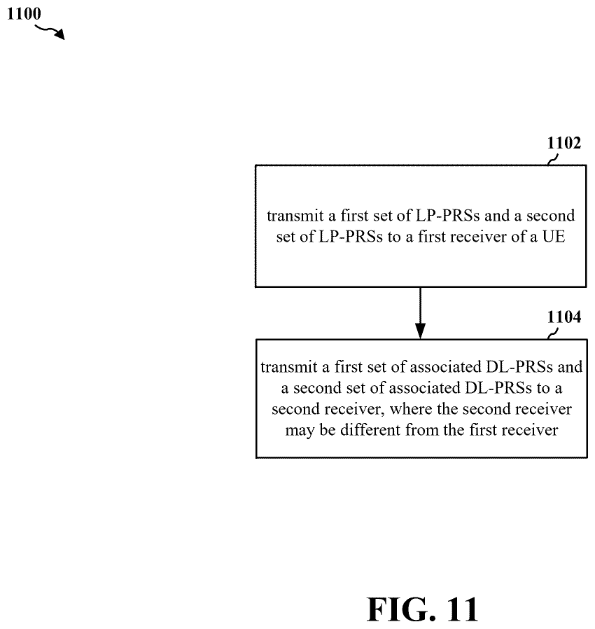

FIG. 11 is a flowchart 1100 of a method of wireless communication. The method may be performed by a second network node (e.g., the base station 102, the base station 310; the TRP 402, the TRP 406, the TRP 504, the TRP 505; the LMF 608, the LMF 708, the LMF 808; the network entity 1202, the network entity 1302, the network entity 1460). At 1102, the second network node may transmit a first set of LP-PRSs and a second set of LP-PRSs to a first receiver of a UE. For example, 1102 may be performed by the serving network node 704 in FIG. 7, which may transmit the set of LP-PRSs 718 to the LPR at the UE 702. The set of LP-PRSs 718 may include a plurality of sets of LP-PRSs, for example the first set of LP-PRSs [LP-PRS #2] and the second set of LP-PRSs [LP-PRS #3, LP-PRS #4] in Table 2. 1102 may be performed by the network 705 in FIG. 7, which may transmit the set of LP-PRSs 718 to the LPR at the UE 702 via the serving network node 704 and the set of LP-PRSs 720 to the LPR at the UE 702 via the neighbor network node 706. Moreover, 1102 may be performed by the component 199 in FIG. 12.

At 1104, the first network node may transmit a first set of associated DL-PRSs and a second set of associated DL-PRSs to a second receiver. The second receiver may be different from the first receiver. For example, 1104 may be performed by the serving network node 704 in FIG. 7, which may transmit the set of DL-PRSs 726 to the HPR at the UE 702. The set of DL-PRSs 726 may include a plurality of sets of DL-PRSs, for example the first set of DL-PRSs [DL-PRS #4, DL-PRS #5, DL-PRS #6] and the second set of DL-PRSs [DL-PRS #7, DL-PRS #8, DL-PRS #9] in Table 2. The LPR at the UE 702 is different than the HPR at the UE 702. 1102 may be performed by the network 705 in FIG. 7, which may transmit the set of DL-PRSs 726 to the HPR at the UE 702 via the serving network node 704 and the set of DL-PRSs 728 to the HPR at the UE 702 via the neighbor network node 706. The LPR at the UE 702 is different than the HPR at the UE 702. Moreover, 1104 may be performed by the component 199 in FIG. 12.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the Tx processor 368, the Rx processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the component 198 may be configured to receive combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of DL-PRSs and a second association configuration between the second set of LP-PRSs and the second set of associated DL-PRSs. The component 198 may be configured to receive the first set of LP-PRSs and the second set of LP-PRSs via a first receiver. The component 198 may be configured to the first set of DL-PRSs and the second set of associated DL-PRSs via a second receiver. The second receiver may be different from the first receiver. The component 198 may be configured to measure the first set of LP-PRSs and the second set of LP-PRSs based on the combined assistance data. The component 198 may be configured to update a priority for measuring the first set DL-PRSs or the second set of associated DL-PRSs based on the measured first set of LP-PRSs and the measured second set of LP-PRSs. The component 198 may be within the cellular baseband processor 1224, the application processor 1206, or both the cellular baseband processor 1224 and the application processor 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for receiving combined assistance data for a first set of LP-PRSs, a second set of LP-PRSs, a first set of associated DL-PRSs, and a second set of associated DL-PRSs. The apparatus 1204 may include means for receiving the first set of LP-PRSs and the second set of LP-PRSs via a first receiver. The apparatus 1204 may include means for receiving the first set of DL-PRSs and the second set of associated DL-PRSs via a second receiver. The apparatus 1204 may include means for measuring the first set of LP-PRSs and the second set of LP-PRSs based on the combined assistance data. The apparatus 1204 may include means for updating a priority for measuring the first set DL-PRSs or the second set of associated DL-PRSs based on the measured first set of LP-PRSs and the measured second set of LP-PRSs. The apparatus 1204 may include means for receiving the combined assistance data for the first set of LP-PRSs, the second set of LP-PRSs, the first set of DL-PRSs, and the second set of associated DL-PRSs by receiving the combined assistance data from an LMF. The apparatus 1204 may include means for receiving the combined assistance data by receiving at least one of an LPP signal or a posSIB. The apparatus 1204 may include means for measuring the first set of LP-PRSs and the second set of LP-PRSs based on the combined assistance data by measuring the first set of LP-PRSs using a first Rx beam. The apparatus 1204 may include means for measuring the first set of DL-PRSs using a second Rx beam. The apparatus 1204 may include means for updating the priority for measuring the first set DL-PRSs or the second set of associated DL-PRSs based on the measured first set of LP-PRSs and the measured second set of LP-PRSs by updating a priority of at least one of a set of DL-PRS resources or updating a priority of beam refinement for a DL-AoD based on the measured first set of LP-PRSs and the measured second set of LP-PRSs. The apparatus 1204 may include means for receiving an updated first set of LP-PRSs and an updated second set of LP-PRSs after receiving the first set of LP-PRSs and the second set of LP-PRSs. The apparatus 1204 may include means for measuring the updated first set of LP-PRSs and the updated second set of LP-PRSs based on the combined assistance data. The apparatus 1204 may include means for revising the priority for measuring the first set DL-PRSs or the second set of associated DL-PRSs based on the measured updated first set of LP-PRSs and the measured updated second set of LP-PRSs. The apparatus 1204 may include means for updating the priority for measuring the first set DL-PRSs or the second set of associated DL-PRSs based on the measured first set of LP-PRSs and the measured second set of LP-PRSs by updating the priority for measuring the first set DL-PRSs or the second set of associated DL-PRSs based on a first set of RSRPs associated with the first set of LP-PRSs and a second set of RSRPs associated with the second set of LP-PRSs. The apparatus 1204 may include means for transmitting a most suitable set of RSRPs based on the first set of RSRPs. The apparatus 1204 may include means for receiving an indication of a set of narrow beams associated with the first set of DL-PRSs. The apparatus 1204 may include means for measuring the set of narrow beams based on the indication of the set of narrow beams. The apparatus 1204 may include means for transmitting an indication of the priority for measuring of the first set DL-PRSs or the second set of associated DL-PRSs based on the measured first set of LP-PRSs and the measured second set of LP-PRSs. The apparatus 1204 may include means for transmitting a most suitable set of RSRPs based on the first set of RSRPs. The apparatus 1204 may include means for receiving an indication of a set of DL-PRS resources associated with the first set of DL-PRSs based on the transmitted most suitable set of RSRPs. The apparatus 1204 may include means for measuring the first set of DL-PRSs based on the indication of the set of DL-PRS resources. The apparatus 1204 may include means for transmitting a most suitable set of RSRPs based on at least one of the first set of RSRPs or the second set of RSRPs. The apparatus 1204 may include means for receiving an indication of a set of DL-PRS resources associated with at least one of the first set of associated DL-PRSs or the second set of associated DL-PRSs based on the transmitted most suitable set of RSRPs. The apparatus 1204 may include means for measuring at least one of the first set of PRSs or the second set of LP-PRSs based on the indication of the set of DL-PRS resources.

The means may be the component 198 of the apparatus 1204 configured to perform the functions recited by the means. As described supra, the apparatus 1204 may include the Tx processor 368, the Rx processor 356, and the controller/processor 359. As such, in one configuration, the means may be the Tx processor 368, the Rx processor 356, and/or the controller/processor 359 configured to perform the functions recited by the means.

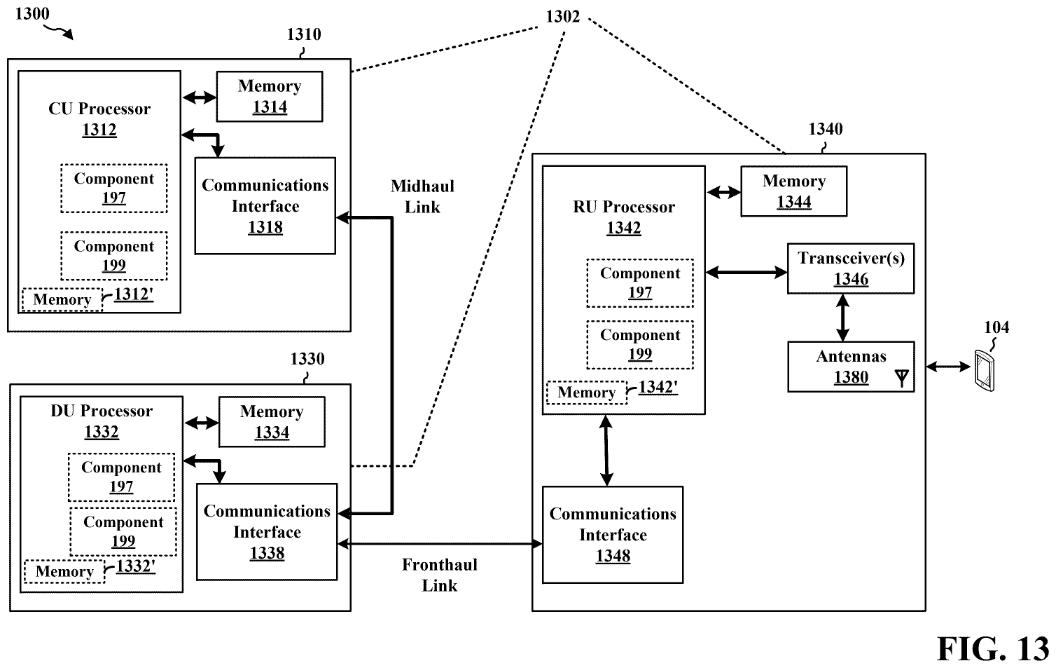

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 197 is configured to transmit combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of DL-PRSs and a second association configuration between the second set of LP-PRSs and the second set of associated DL-PRSs. The component 197 may be configured to receive an indication of a priority for measuring the first set DL-PRSs or the second set of associated DL-PRSs based on the first set of LP-PRSs and the second set of LP-PRSs. The component 197 may be within one or more processors of one or more of the CU 1310, DU 1330, and the RU 1340. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for transmitting combined assistance data for a first set of LP-PRSs, a second set of LP-PRSs, a first set of associated DL-PRSs, and a second set of associated DL-PRSs. The network entity 1302 may include means for receiving an indication of a priority for measuring the first set DL-PRSs or the second set of associated DL-PRSs based on the first set of LP-PRSs and the second set of LP-PRSs. The network entity 1302 may include means for transmitting the combined assistance data by transmitting at least one of an LPP signal or a posSIB. The network entity 1302 may include means for receiving a most suitable set of RSRPs based on a first set of RSRPs based on the first set of LP-PRSs. The network entity 1302 may include means for transmitting a second indication of a set of narrow beams associated with the first set of DL-PRSs. The network entity 1302 may include means for receiving a most suitable set of RSRPs based on at least one of a first set of RSRPs based on the first set of LP-PRSs or a second set of RSRPs based on the second set of LP-PRSs. The network entity 1302 may include means for transmitting a second indication of a set of DL-PRS resources associated with at least one of the first set of associated DL-PRSs or the second set of associated DL-PRSs based on the received most suitable set of RSRPs. The means may be the component 197 of the network entity 1302 configured to perform the functions recited by the means. As described supra, the network entity 1302 may include the Tx processor 316, the Rx processor 370, and the controller/processor 375. As such, in one configuration, the means may be the Tx processor 316, the Rx processor 370, and/or the controller/processor 375 configured to perform the functions recited by the means.

As discussed supra, the component 199 is configured to transmit a first set of LP-PRSs and a second set of LP-PRSs to a first receiver of a UE. The component 199 may be configured to transmit a first set of associated DL-PRSs and a second set of associated DL-PRSs to a second receiver. The second receiver may be different from the first receiver. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for transmitting a first set of LP-PRSs and a second set of LP-PRSs to a first receiver of a UE. The network entity 1302 may include means for transmitting a first set of associated DL-PRSs and a second set of associated DL-PRSs to a second receiver. The network entity 1302 may include means for transmitting the first set of LP-PRSs and the second set of LP-PRSs to the first receiver of the UE by transmitting the first set of LP-PRSs and the second set of LP-PRSs via the TRP to the first receiver of the UE. The network entity 1302 may include means for transmitting the first set of DL-PRSs and the second set of associated DL-PRSs to the second receiver of the UE by transmitting the first set of DL-PRSs and the second set of associated DL-PRSs via the TRP to the second receiver of the UE. The network entity 1302 may include means for transmitting the first set of LP-PRSs and the second set of LP-PRSs to the first receiver of the UE by transmitting the first set of LP-PRSs and the second set of LP-PRSs via the first TRP to the first receiver of the UE. The network entity 1302 may include means for transmitting the first set of DL-PRSs and the second set of associated DL-PRSs to the second receiver of the UE by transmitting the first set of DL-PRSs and the second set of associated DL-PRSs via the second TRP to the second receiver of the UE. The network entity 1302 may include means for transmitting an updated first set of LP-PRSs and an updated second set of LP-PRSs after transmitting the first set of LP-PRSs and the second set of LP-PRSs. The network entity 1302 may include means for transmitting a first set of LP-PRSs and a second set of LP-PRSs from a first TRP to a first receiver of a UE. The network entity 1302 may include means for transmitting a first set of associated DL-PRSs and a second set of associated DL-PRSs from a second TRP to a second receiver. The means may be the component 199 of the network entity 1302 configured to perform the functions recited by the means. As described supra, the network entity 1302 may include the Tx processor 316, the Rx processor 370, and the controller/processor 375. As such, in one configuration, the means may be the Tx processor 316, the Rx processor 370, and/or the controller/processor 375 configured to perform the functions recited by the means.

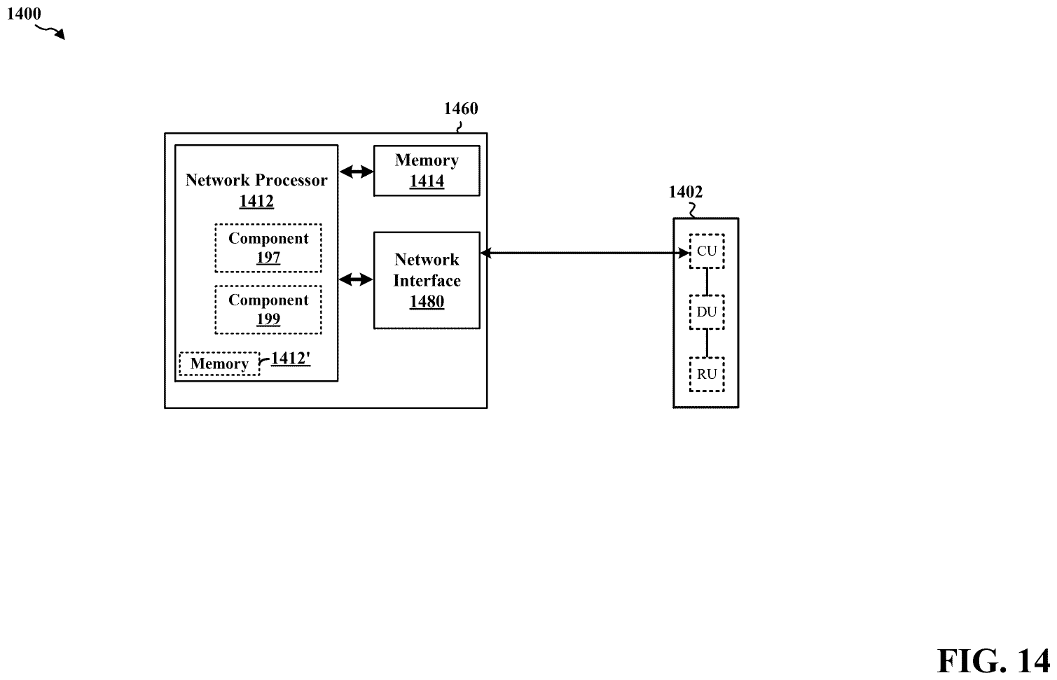

FIG. 14 is a diagram 1400 illustrating an example of a hardware implementation for a network entity 1460. In one example, the network entity 1460 may be within the core network 120. The network entity 1460 may include a network processor 1412. The network processor 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The processor 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 197 is configured to transmit combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of DL-PRSs and a second association configuration between the second set of LP-PRSs and the second set of associated DL-PRSs. The component 197 may be configured to receive an indication of a priority for measuring the first set DL-PRSs or the second set of associated DL-PRSs based on the first set of LP-PRSs and the second set of LP-PRSs. The component 197 may be within one or more processors of one or more of the CU 1310, DU 1330, and the RU 1340. The component 197 may be within the processor 1412. The component 197 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1460 may include a variety of components configured for various functions. In one configuration, the network entity 1460 includes means for transmitting combined assistance data for a first set of LP-PRSs, a second set of LP-PRSs, a first set of associated DL-PRSs, and a second set of associated DL-PRSs. The network entity 1460 may include means for receiving an indication of a priority for measuring the first set DL-PRSs or the second set of associated DL-PRSs based on the first set of LP-PRSs and the second set of LP-PRSs. The network entity 1460 may include means for transmitting the combined assistance data by transmitting at least one of an LPP signal or a posSIB. The network entity 1460 may include means for receiving a most suitable set of RSRPs based on a first set of RSRPs based on the first set of LP-PRSs. The network entity 1460 may include means for transmitting a second indication of a set of narrow beams associated with the first set of DL-PRSs. The means may be the component 197 of the network entity 1460 configured to perform the functions recited by the means.

As discussed supra, the component 199 is configured to transmit a first set of LP-PRSs and a second set of LP-PRSs to a first receiver of a UE. The component 199 may be configured to transmit a first set of associated DL-PRSs and a second set of associated DL-PRSs to a second receiver. The second receiver may be different from the first receiver. The component 199 may be within the processor 1412. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1460 may include a variety of components configured for various functions. In one configuration, the network entity 1460 includes means for transmitting a first set of LP-PRSs and a second set of LP-PRSs to a first receiver of a UE. The network entity 1460 may include means for transmitting a first set of associated DL-PRSs and a second set of associated DL-PRSs to a second receiver. The network entity 1460 may include means for transmitting the first set of LP-PRSs and the second set of LP-PRSs to the first receiver of the UE by transmitting the first set of LP-PRSs and the second set of LP-PRSs via the TRP to the first receiver of the UE. The network entity 1460 may include means for transmitting the first set of DL-PRSs and the second set of associated DL-PRSs to the second receiver of the UE by transmitting the first set of DL-PRSs and the second set of associated DL-PRSs via the TRP to the second receiver of the UE. The network entity 1460 may include means for transmitting the first set of LP-PRSs and the second set of LP-PRSs to the first receiver of the UE by transmitting the first set of LP-PRSs and the second set of LP-PRSs via the first TRP to the first receiver of the UE. The network entity 1460 may include means for transmitting the first set of DL-PRSs and the second set of associated DL-PRSs to the second receiver of the UE by transmitting the first set of DL-PRSs and the second set of associated DL-PRSs via the second TRP to the second receiver of the UE. The network entity 1460 may include means for transmitting an updated first set of LP-PRSs and an updated second set of LP-PRSs after transmitting the first set of LP-PRSs and the second set of LP-PRSs. The means may be the component 199 of the network entity 1460 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. A subset should be interpreted as a set smaller than the set upon which the subset refers. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include receiving combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of DL-PRSs and a second association configuration between the second set of LP-PRSs and the second set of associated DL-PRSs. The method may include receiving the first set of LP-PRSs and the second set of LP-PRSs via a first receiver. The method may include receiving the first set of DL-PRSs and the second set of associated DL-PRSs via a second receiver. The second receiver may be different from the first receiver. The method may include measuring the first set of LP-PRSs and the second set of LP-PRSs based on the combined assistance data. The method may include updating a priority for measuring the first set DL-PRSs or the second set of associated DL-PRSs based on the measured first set of LP-PRSs and the measured second set of LP-PRSs.

Aspect 2 is the method of aspect 1, where the first receiver may include an LP-WUR. The second receiver may include an MR.

Aspect 3 is the method of any of aspects 1 and 2, where receiving the combined assistance data for the first set of LP-PRSs, the second set of LP-PRSs, the first set of DL-PRSs, and the second set of associated DL-PRSs may include receiving the combined assistance data from an LMF.

Aspect 4 is the method of any of aspects 1 to 3, where receiving the combined assistance data may include receiving at least one of an LPP signal or a posSIB.

Aspect 5 is the method of any of aspects 1 to 4, where the first association configuration may include at least one of a TRP, a set of DL-PRSs, or a set of resources between the first set of LP-PRSs and the first set of DL-PRSs.

Aspect 6 is the method of any of aspects 1 to 5, where the first association configuration may include a spatial relationship between the first set of LP-PRSs and the first set of DL-PRSs.

Aspect 7 is the method of aspect 6, where the spatial relationship between the first set of LP-PRSs and the first set of DL-PRSs may include at least one of a set of Tx beams, a set of adjacent Tx beams, a TRP, or a set of boresight direction information.

Aspect 8 is the method of any of aspects 1 to 7, where measuring the first set of LP-PRSs and the second set of LP-PRSs based on the combined assistance data may include measuring the first set of LP-PRSs using a first Rx beam. The method may include measuring the first set of DL-PRSs using a second Rx beam. The first Rx beam may be different from the second Rx beam.

Aspect 9 is the method of any of aspects 1 to 8, where the first set of DL-PRSs and the second set of associated DL-PRSs share a same TRP.

Aspect 10 is the method of any of aspects 1 to 9, where updating the priority for measuring the first set DL-PRSs or the second set of associated DL-PRSs based on the measured first set of LP-PRSs and the measured second set of LP-PRSs may include updating a priority of at least one of a set of DL-PRS resources or updating a priority of beam refinement for a DL-AoD based on the measured first set of LP-PRSs and the measured second set of LP-PRSs.

Aspect 11 is the method of any of aspects 1 to 10, where the method may include receiving an updated first set of LP-PRSs and an updated second set of LP-PRSs after receiving the first set of LP-PRSs and the second set of LP-PRSs. The method may include measuring the updated first set of LP-PRSs and the updated second set of LP-PRSs based on the combined assistance data. The method may include revising the priority for measuring the first set DL-PRSs or the second set of associated DL-PRSs based on the measured updated first set of LP-PRSs and the measured updated second set of LP-PRSs.

Aspect 12 is the method of any of aspects 1 to 11, where updating the priority for measuring the first set DL-PRSs or the second set of associated DL-PRSs based on the measured first set of LP-PRSs and the measured second set of LP-PRSs may include updating the priority for measuring the first set DL-PRSs or the second set of associated DL-PRSs based on a first set of RSRPs associated with the first set of LP-PRSs and a second set of RSRPs associated with the second set of LP-PRSs.

Aspect 13 is the method of any of aspects 1 to 12, where the method may include transmitting a most suitable set of RSRPs based on the first set of RSRPs. The method may include receiving an indication of a set of narrow beams associated with the first set of DL-PRSs. The method may include measuring the set of narrow beams based on the indication of the set of narrow beams.

Aspect 14 is the method of any of aspects 1 to 13, where the first set of LP-PRSs may have a first waveform. The first set of DL-PRSs may have a second waveform. The second waveform may be different from the first waveform.

Aspect 15 is the method of any of aspects 1 to 14, where the method may include transmitting an indication of the priority for measuring of the first set DL-PRSs or the second set of associated DL-PRSs based on the measured first set of LP-PRSs and the measured second set of LP-PRSs.

Aspect 16 is a method of wireless communication at a first network node, where the method may include transmitting combined assistance data for a first set of LP-PRSs, a second set of LP-PRSs, a first set of associated DL-PRSs, and a second set of associated DL-PRSs. The combined assistance data may include a first association configuration between the first set of LP-PRSs and the first set of DL-PRSs and a second association configuration between the second set of LP-PRSs and the second set of associated DL-PRSs. The method may include receiving an indication of a priority for measuring the first set DL-PRSs or the second set of associated DL-PRSs based on the first set of LP-PRSs and the second set of LP-PRSs.

Aspect 17 is the method of aspect 16, where the first network node may include an LMF.

Aspect 18 is the method of either of aspects 16 or 17, where transmitting the combined assistance data may include transmitting at least one of an LPP signal or a posSIB.

Aspect 19 is the method of any of aspects 16 to 18, where the first association configuration may include at least one of a TRP, a set of DL-PRSs, or a set of resources between the first set of LP-PRSs and the first set of DL-PRSs.

Aspect 20 is the method of any of aspects 16 to 19, where the first association configuration may include a spatial relationship between the first set of LP-PRSs and the first set of DL-PRSs.

Aspect 21 is the method of aspect 20, where the spatial relationship between the first set of LP-PRSs and the first set of DL-PRSs may include at least one of a set of Tx beams, a set of adjacent Tx beams, a TRP, or a set of boresight direction information.

Aspect 22 is the method of any of aspects 16 to 21, where the first set of DL-PRSs and the second set of associated DL-PRSs may share a same TRP.

Aspect 23 is the method of any of aspects 16 to 22, where the method may include receiving a most suitable set of RSRPs based on a first set of RSRPs based on the first set of LP-PRSs. The method may include transmitting a second indication of a set of narrow beams associated with the first set of DL-PRSs.

Aspect 24 is the method of any of aspects 16 to 23, where the first set of LP-PRSs may have a first waveform. The first set of DL-PRSs may have a second waveform. The second waveform may be different from the first waveform.

Aspect 25 is a method of wireless communication at a second network node, where the method may include transmitting a first set of LP-PRSs and a second set of DL-PRSs to a first receiver of a UE. The method may include transmitting a first set of associated DL-PRSs and a second set of associated DL-PRSs to a second receiver. The second receiver may be different from the first receiver.

Aspect 26 is the method of aspect 25, where the first receiver may include an LP-WUR. The second receiver may include an MR.

Aspect 27 is the method of either of aspects 25 or 26, where the second network node may include a TRP. Transmitting the first set of LP-PRSs and the second set of LP-PRSs to the first receiver of the UE may include transmitting the first set of LP-PRSs and the second set of LP-PRSs via the TRP to the first receiver of the UE. Transmitting the first set of DL-PRSs and the second set of associated DL-PRSs to the second receiver of the UE may include transmitting the first set of DL-PRSs and the second set of associated DL-PRSs via the TRP to the second receiver of the UE.

Aspect 28 is the method of any of aspects 25 to 27, where the second network node may include a first TRP and a second TRP. Transmitting the first set of LP-PRSs and the second set of LP-PRSs to the first receiver of the UE may include transmitting the first set of LP-PRSs and the second set of LP-PRSs via the first TRP to the first receiver of the UE. Transmitting the first set of DL-PRSs and the second set of associated DL-PRSs to the second receiver of the UE may include transmitting the first set of DL-PRSs and the second set of associated DL-PRSs via the second TRP to the second receiver of the UE.

Aspect 29 is the method of any of aspects 25 to 28, where the method may include transmitting an updated first set of LP-PRSs and an updated second set of LP-PRSs after transmitting the first set of LP-PRSs and the second set of LP-PRSs.

Aspect 30 is the method of any of aspects 25 to 29, where the first set of LP-PRSs may have a first waveform. The first set of DL-PRSs may have a second waveform. The second waveform may have different from the first waveform.

Aspect 31 is the method of any of aspects 1 to 15, where the first association configuration may include an association between each of the first set of LP-PRSs and each of the first set of DL-PRSs.

Aspect 32 is the method of any of aspects 1 to 15 or 31, where the first association configuration may include an association between each of the first set of LP-PRSs and a subset of the first set of DL-PRSs.

Aspect 33 is the method of any of aspects 1 to 15 or 31-32, where the first receiver may have a lower power consumption than the second receiver.

Aspect 34 is the method of aspect 10, where the method may include transmitting a most suitable set of RSRPs based on at least one of the first set of RSRPs or the second set of RSRPs. The method may include receiving an indication of a set of DL-PRS resources associated with at least one of the first set of associated DL-PRSs or the second set of associated DL-PRSs based on the transmitted most suitable set of RSRPs. The method may include measuring at least one of the first set of PRSs or the second set of LP-PRSs based on the indication of the set of DL-PRS resources.

Aspect 35 is the method of aspect 14, where the first waveform may include at least one of an OOK waveform or an amplitude-shift keying based modulated waveform. The second waveform may include an OFDM waveform.

Aspect 36 is the method of any of aspects 16 to 24, where the first association configuration may include an association between each of the first set of LP-PRSs and each of the first set of DL-PRSs.

Aspect 37 is the method of any of aspects 16 to 24 or 36, where the first association configuration may include an association between each of the first set of LP-PRSs and a subset of the first set of DL-PRSs.

Aspect 38 is the method of any of aspects 16 to 24 or 36 to 37, where the method may include receiving a most suitable set of RSRPs based on at least one of a first set of RSRPs based on the first set of LP-PRSs or a second set of RSRPs based on the second set of LP-PRSs. The method may include transmitting a second indication of a set of DL-PRS resources associated with at least one of the first set of associated DL-PRSs or the second set of associated DL-PRSs based on the received most suitable set of RSRPs.

Aspect 39 is the method of aspect 24, where the first waveform may include at least one of an OOK waveform or an amplitude-shift keying based modulated waveform. The second waveform may include an OFDM waveform.

Aspect 40 is a method of wireless communication at a second network node, where the method may include transmitting a first set of LP-PRSs and a second set of LP-PRSs from a first TRP to a first receiver of a UE. The method may include transmitting a first set of associated DL-PRSs and a second set of associated DL-PRSs from a second TRP to a second receiver. The second receiver may be different from the first receiver.

Aspect 41 is the method of aspect 40, where the first receiver may include an LP-WUR. The second receiver may include an MR.

Aspect 42 is the method of either of aspects 40 or 41, where the method may include transmitting an updated first set of LP-PRSs and an updated second set of LP-PRSs after transmitting the first set of LP-PRSs and the second set of LP-PRSs.

Aspect 43 is the method of any of aspects 40 to 42, where the first set of LP-PRSs may have a first waveform. The first set of DL-PRSs may have a second waveform. The second waveform may have different from the first waveform.

Aspect 44 is the method of aspect 43, where the first waveform may include at least one of an OOK waveform or an amplitude-shift keying based modulated waveform. The second waveform may include an OFDM waveform.

Aspect 45 is an apparatus for wireless communication, including: a memory; and at least one processor coupled to the memory and, based at least in part on information stored in the memory, the at least one processor is configured to implement any of aspects 1 to 44.

Aspect 46 is the apparatus of aspect 45, further including at least one of an antenna or a transceiver coupled to the at least one processor.

Aspect 47 is an apparatus for wireless communication including means for implementing any of aspects 1 to 44.

Aspect 48 is a computer-readable medium (e.g., a non-transitory computer-readable medium) storing computer executable code, where the code when executed by a processor causes the processor to implement any of aspects 1 to 44.

1. An apparatus for wireless communication at a user equipment (UE), comprising:
a memory; and
at least one processor coupled to the memory and, based at least in part on information stored in the memory, the at least one processor is configured to:
receive combined assistance data for a first set of low-power (LP) positioning reference signals (LP-PRSs), a second set of LP-PRSs, a first set of associated downlink (DL) positioning reference signals (DL-PRSs), and a second set of associated DL-PRSs, wherein the combined assistance data comprises a first association configuration between the first set of LP-PRSs and the first set of associated DL-PRSs and a second association configuration between the second set of LP-PRSs and the second set of associated DL-PRSs:
receive the first set of LP-PRSs and the second set of LP-PRSs via a first receiver and receive the first set of associated DL-PRSs and the second set of associated DL-PRSs via a second receiver, wherein the second receiver is different from the first receiver:
measure the first set of LP-PRSs and the second set of LP-PRSs based on the combined assistance data; and
update a priority for a measurement of the first set of associated DL-PRSs or the second set of associated DL-PRSs based on the first set of LP-PRSs and the second set of LP-PRSs.

2. The apparatus of claim 1, wherein the first receiver has a lower power consumption than the second receiver.

3. The apparatus of claim 1, further comprising a transceiver coupled to the at least one processor, wherein, to receive the combined assistance data for the first set of LP-PRSs, the second set of LP-PRSs, the first set of associated DL-PRSs, and the second set of associated DL-PRSs, the at least one processor is configured to:
receive, via the transceiver, the combined assistance data from a location management function (LMF).

4. The apparatus of claim 1, wherein, to receive the combined assistance data, the at least one processor is configured to:
receive at least one of a long term evolution (LTE) positioning protocol (LPP) signal or a positioning system information block (posSIB).

5. The apparatus of claim 1, wherein the first association configuration comprises an association between each of the first set of LP-PRSs and each of the first set of associated DL-PRSs.

6. The apparatus of claim 1, wherein the first association configuration comprises an association between each of the first set of LP-PRSs and a subset of the first set of associated DL-PRSs.

7. The apparatus of claim 1, wherein the first association configuration comprises a spatial relationship between the first set of LP-PRSs and the first set of associated DL-PRSs.

8. The apparatus of claim 7, wherein the spatial relationship between the first set of LP-PRSs and the first set of associated DL-PRSs comprises at least one of a set of transmission (Tx) beams, a set of adjacent Tx beams, a transmission reception point (TRP), or a set of boresight direction information.

9. The apparatus of claim 1, wherein, to update the priority for the measurement of the first set of associated DL-PRSs or the second set of associated DL-PRSs based on the first set of LP-PRSs and the second set of LP-PRSs, the at least one processor is configured to:
update at least one of a second priority of at least one of a set of DL-PRS resources based on the first set of LP-PRSs and the second set of LP-PRSs.

10. The apparatus of claim 1, wherein the at least one processor is further configured to:
receive an updated first set of LP-PRSs and an updated second set of LP-PRSs after the at least one processor is configured receive the first set of LP-PRSs and the second set of LP-PRSs:
measure the updated first set of LP-PRSs and the updated second set of LP-PRSs based on the combined assistance data; and
revise the priority for the measurement of the first set of associated DL-PRSs or the second set of associated DL-PRSs based on the updated first set of LP-PRSs and the updated second set of LP-PRSs.

11. The apparatus of claim 1, wherein, to update the priority for the measurement of the first set of associated DL-PRSs or the second set of associated DL-PRSs based on the first set of LP-PRSs and the second set of LP-PRSs, the at least one processor is configured to:
update the priority for the measurement of the first set of associated DL-PRSs or the second set of associated DL-PRSs based on a first set of reference signal received power (RSRPs) associated with the first set of LP-PRSs and a second set of RSRPs associated with the second set of LP-PRSs.

12. The apparatus of claim 11, wherein the at least one processor is further configured to:
transmit a most suitable set of RSRPs based on at least one of the first set of RSRPs or the second set of RSRPs:
receive an indication of a set of DL-PRS resources associated with at least one of the first set of associated DL-PRSs or the second set of associated DL-PRSs based on the most suitable set of RSRPs; and
measure at least one of the first set of PRSs or the second set of LP-PRSs based on the indication of the set of DL-PRS resources.

13. The apparatus of claim 1, wherein the first set of LP-PRSs has a first waveform, wherein the first set of associated DL-PRSs has a second waveform, wherein the second waveform is different from the first waveform.

14. The apparatus of claim 13, wherein the first waveform comprises at least one of an on-off keying (OOK) waveform or an amplitude-shift keying based modulated waveform, wherein the second waveform comprises an orthogonal frequency division multiplexing (OFDM) waveform.

15. The apparatus of claim 1, wherein the at least one processor is further configured to:
transmit an indication of the priority for the measurement of the first set of associated DL-PRSs or the second set of associated DL-PRSs based on the first set of LP-PRSs and the second set of LP-PRSs.

16. An apparatus for wireless communication at a first network node, comprising:
a memory; and
at least one processor coupled to the memory and, based at least in part on information stored in the memory, the at least one processor is configured to:
transmit combined assistance data for a first set of low-power (LP) positioning reference signal (LP-PRSs), a second set of LP-PRSs, a first set of associated downlink (DL) positioning reference signals (DL-PRSs), and a second set of associated DL-PRSs, wherein the combined assistance data comprises a first association configuration between the first set of LP-PRSs and the first set of associated DL-PRSs and a second association configuration between the second set of LP-PRSs and the second set of associated DL-PRSs; and
receive an indication of a priority for a measurement of the first set of associated DL-PRSs or the second set of associated DL-PRSs based on the first set of LP-PRSs and the second set of LP-PRSs.

17. The apparatus of claim 16, wherein the first network node comprises a location management function (LMF).

18-25. (canceled)

26. A method of wireless communication at a user equipment (UE), comprising:
receiving combined assistance data for a first set of low-power (LP) positioning reference signals (LP-PRSs), a second set of LP-PRSs, a first set of associated downlink (DL) positioning reference signals (DL-PRSs), and a second set of associated DL-PRSs, wherein the combined assistance data comprises a first association configuration between the first set of LP-PRSs and the first set of associated DL-PRSs and a second association configuration between the second set of LP-PRSs and the second set of associated DL-PRSs:
receiving the first set of LP-PRSs and the second set of LP-PRSs via a first receiver and receiving the first set of associated DL-PRSs and the second set of associated DL-PRSs via a second receiver, wherein the second receiver is different from the first receiver:
measuring the first set of LP-PRSs and the second set of LP-PRSs based on the combined assistance data; and
updating a priority for a measurement of the first set of associated DL-PRSs or the second set of associated DL-PRSs based on the measured first set of LP-PRSs and the measured second set of LP-PRSs.

27. The method of claim 26, further comprising:
receiving an updated first set of LP-PRSs and an updated second set of LP-PRSs after receiving the first set of LP-PRSs and the second set of LP-PRSs:
measuring the updated first set of LP-PRSs and the updated second set of LP-PRSs based on the combined assistance data; and
revising the priority for the measurement of the first set of associated DL-PRSs or the second set of associated DL-PRSs based on the measured updated first set of LP-PRSs and the measured updated second set of LP-PRSs.

28. The method of claim 26, further comprising:
transmitting an indication of the priority for the measurement of the first set of associated DL-PRSs or the second set of associated DL-PRSs based on the measured first set of LP-PRSs and the measured second set of LP-PRSs.

29-30. (canceled)
